(19) United States
(12) Patent Application Publication
(10) Pub. No.: US 2018/0157149 A1
(43) Pub. Date: Jun. 7, 2018

(54) QUASI-PHASE-MATCHED FREQUENCY DOUBLING OF BROADBAND LIGHT WITH UNCORRELATED SPECTRAL PHASE

(71) Applicant: Dolby Laboratories Licensing Corporation, San Francisco, CA (US)

(72) Inventors: Alireza MARANDI, Menlo Park, CA (US); Gennady IMESHEV, Irvine, CA (US); Dzhakhangir V. KHAYDAROV, Campbell, CA (US); Gregory David MILLER, San Jose, CA (US)

(73) Assignee: Dolby Laboratories Licensing Corporation, San Francisco, CA (US)

(21) Appl. No.: 15/822,922

(22) Filed: Nov. 27, 2017

Related U.S. Application Data
(60) Provisional application No. 62/428,666, filed on Dec. 1, 2016.

(51) Int. Cl. G02F 1/377; H01S 3/109; G03B 21/20

(52) U.S. Cl. CPC G02F 1/3775; G03B 21/206; G03B 21/2033; H01S 3/109

(57) ABSTRACT

A device for quasi-phase-matched frequency doubling of broadband light with uncorrelated spectral phase includes a nonlinear optical material, which in turn includes a domain-reversed grating organized in a series of sections along propagation direction of the broadband light through the nonlinear optical material. Each of the sections is characterized by a respective period of the domain-reversed grating. The period within a first connected subset of the series alternates between two discrete values along the propagation direction. A method for designing the domain-reversed grating includes determining a grating function model describing an ideal nonlinear coefficient of a domain-reversed grating, and discretizing the grating function model to a manufacturable grating function having period restricted to a discrete set of manufacturable periods.

### CROSS-REFERENCE TO RELATED APPLICATIONS

This application claims priority to U.S. Provisional Patent Application No. 62/428,666 filed on Dec. 1, 2016, which is hereby incorporated by reference in its entirety.

### TECHNICAL FIELD

The present application relates to frequency doubling of broadband light in a nonlinear optical material. More specifically, the present application relates to quasi-matched frequency doubling of broadband light with uncorrelated spectral phase in a domain-reversed nonlinear medium.

### BACKGROUND

Digital projectors have become the default movie projection system for cinemas throughout most of the world. Light projected by these digital projectors typically is generated by a xenon lamp emitting white light, that is, light than spans the full extent of the visible color spectrum. Optical elements select the primary color components, e.g., red, green, and blue, from the white light and project these color components onto a screen to form the movie image. However, only a small fraction of the light generated by the xenon lamp falls within the desired primary color components and the remaining light generated by the xenon lamp is wasted. This lack of efficiency ultimately limits the image brightness attainable with a xenon lamp-based projector.

Lasers are emerging as an alternative to the xenon lamp. Lasers may be selected, configured, and/or manipulated to generate only the light needed for projection, thus greatly improving the efficiency of light generation. In addition, the spatially coherent nature of laser beams provides for further improvement in efficiency since the light emitted by the laser is easily collected and directed to the screen. By virtue of these efficiency improvements, laser based projectors are ultimately capable of producing greater image brightness.

### SUMMARY

In an embodiment, a device for quasi-phase-matched frequency doubling of broadband light with uncorrelated spectral phase includes a nonlinear optical material, which in turn includes a domain-reversed grating organized in a series of sections along propagation direction of the broadband light through the nonlinear optical material. Each of the sections is characterized by a respective period of the domain-reversed grating. The period within a first connected subset of the series alternates between two discrete values along the propagation direction.

In an embodiment, a system for generating broadband frequency-doubled light includes a laser for emitting a broadband laser beam containing a plurality of frequency components having uncorrelated spectral phase. The system further includes a frequency doubler coupled with the laser. The frequency doubler includes a domain-reversed grating, in a nonlinear optical material, for quasi-phase-matched frequency doubling of the plurality of frequency components to generate the broadband frequency-doubled light. The period of domain-reversal in the domain-reversed grating exhibits variation along the propagation direction of the broadband laser beam through the nonlinear optical material.

In an embodiment, a method for manufacturing a frequency doubler for quasi-phase-matched frequency doubling of broadband light with uncorrelated spectral phase includes poling a nonlinear optical material to form a domain-reversed grating, which has a plurality of sections organized along propagation direction of the broadband light through the nonlinear optical material. Each of the sections is characterized by a respective period of the domain-reversed grating. The period within at least a connected subset of the series alternates between two discrete values along the propagation direction.

In an embodiment, a method for designing a domain-reversed grating for quasi-phase-matched frequency doubling of broadband light with uncorrelated spectral phase includes determining a grating function model describing an ideal nonlinear coefficient of a domain-reversed grating, for quasi-phase-matched frequency doubling of the broadband light in a nonlinear optical material, as a function of the position along the light propagation direction through the nonlinear optical material. The period of the modeled grating function exhibits variation as a function of the position. The method further includes discretizing the grating function model to a manufacturable grating function having period restricted to a discrete set of manufacturable periods.

### BRIEF DESCRIPTION OF THE DRAWINGS

FIG. 1 illustrates a system for generating broadband frequency-doubled light 1, according to an embodiment.

FIG. 2 illustrates, by examples, uncorrelated spectral phase.

FIG. 3 illustrates a method for designing a domain-reversed grating for quasi-phase-matched frequency doubling of broadband laser light with uncorrelated spectral phase, according to an embodiment.

FIG. 4 illustrates a method for iteratively determining a grating function model, according to an embodiment.

FIG. 5 illustrates a method for discretizing a grating function model to a manufacturable grating function having period restricted to a discrete set of manufacturable periods, according to an embodiment.

FIG. 6A shows one exemplary continuous domain-reversal period function determined by the method of FIG. 4.

FIG. 6B shows one exemplary discretized period corresponding the continuous domain-reversal period function of FIG. 6A.

FIG. 7 schematically illustrates a domain-reversed grating having a non-uniform domain-reversal period, according to an embodiment.

FIG. 8 schematically illustrates another domain-reversed grating having a non-uniform domain-reversal period, according to an embodiment.

FIG. 9 shows exemplary design results for a domain-reversed grating of FIG. 1, according to an embodiment.

FIG. 10 shows actual measurements of the spectral intensity profile of frequency-doubled light generated in two different domain-reversed gratings manufactured according to the design of FIG. 9.

FIG. 11 shows exemplary design results for another domain-reversed grating of FIG. 1, according to an embodiment.

FIG. 12 shows actual measurements of the transfer function for an exemplary domain-reversed grating designed according to an output transfer function of FIG. 11, with the period of domain reversal being discretized using an embodiment of the method of FIG. 5.

FIG. 13 illustrates, by example, the impact of temperature on quasi-phase-matched frequency doubling.

FIG. 14 illustrates a bulk domain-reversed grating in a scenario, wherein the broadband input light is a collimated broadband laser beam, according to an embodiment.

FIG. 15 illustrates a bulk domain-reversed grating in a scenario, wherein the broadband input light is a focused broadband laser beam, according to an embodiment.

FIG. 16 illustrates a waveguide-based domain-reversed grating, according to an embodiment.

FIG. 17 illustrates a frequency-doubled broadband light source, according to an embodiment.

FIG. 18 illustrates a diode laser based frequency-doubled broadband light source for generating broadband frequency-doubled light from a plurality of diode lasers through quasi-phase-matched frequency doubling in a domain-reversed grating, according to an embodiment.

FIG. 19 illustrates a multi-colored light system that includes the frequency-doubled broadband light source of FIG. 17, according to an embodiment.

FIGS. 20A and 20B illustrate a tricolor projection system that includes a frequency-doubled broadband green light source, a red light source, and a blue light source, according to an embodiment.

FIG. 21 illustrates a method for manufacturing a frequency doubler for quasi-phase-matched frequency doubling of broadband light with uncorrelated spectral phase, according to an embodiment.

### DESCRIPTION OF EXAMPLE EMBODIMENTS

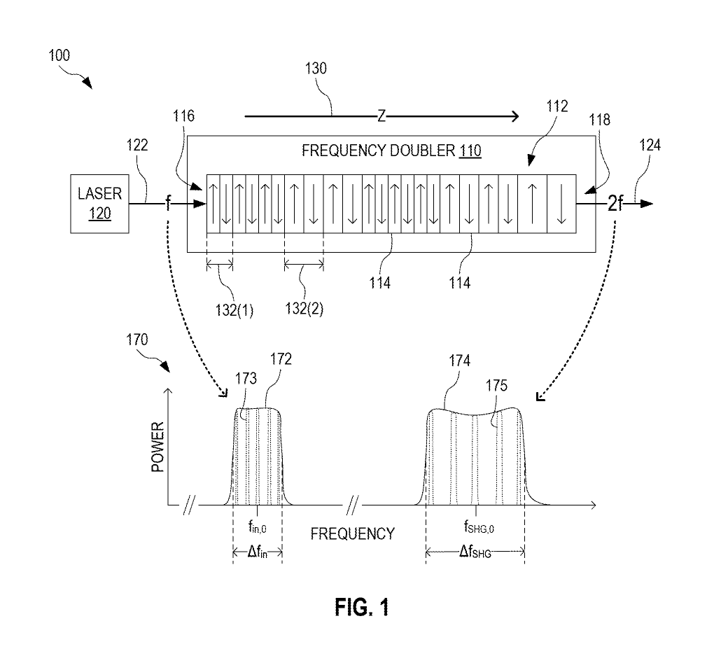

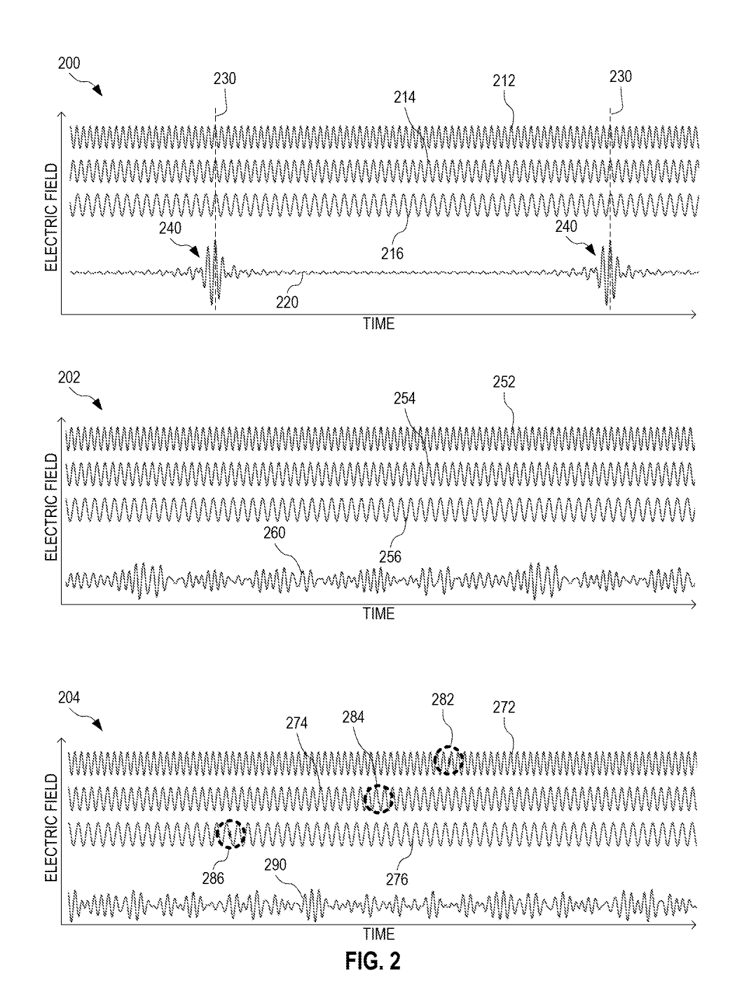

FIG. 1 illustrates one exemplary system 100 for generating broadband frequency-doubled light 124. Certain embodiments of system 100 may advantageously be implemented in a digital cinema projector, but the applicability of system 100 is not limited to digital cinema projectors. System 100 is configured to frequency-double broadband laser light 122 having uncorrelated spectral phase, that is, broadband laser light 122 includes a plurality of spectral components with respective phases that are uncorrelated with each other. The term “uncorrelated spectral phase” is illustrated by example in FIG. 2. System 100 may be useful in applications that require broadband light in a wavelength range that cannot be generated using conventional or low-cost light sources of sufficient brightness. In one exemplary application, system 100 frequency doubles broadband laser light generated by a low-cost laser system (such as a collection of low-cost laser diodes) to produce broadband laser light in a wavelength range that is not covered by low-cost laser systems. In another exemplary application, system 100 frequency doubles broadband laser light generated by a collection of low-cost laser diodes to produce broadband laser light in a wavelength range at a power level that would be cost-prohibitive to achieve directly with laser diodes in this wavelength range.

FIG. 2 includes three plots 200, 202, and 204. Plot 200 shows the electric field as a function of time for spectral components that are phased locked to each other. Plot 202 shows the electric field as a function of time for spectral components having a random but fixed phase relationship. Plot 204 shows the electric field as a function of time for spectral components having a random phase relationship and further exhibiting occasional phase shifts. Plots 200 and 202 are examples of correlated spectral phase, whereas plot 204 is an example of uncorrelated spectral phase.

Plot 200 shows the sum 220 of a plurality of spectral components, including spectral components 212, 214, and 216, that are phase locked to each other. Since the phases of these spectral components are locked to each other, the spectral components all come into phase with each other at regular intervals, indicated by times 230. This leads to constructive interference of the spectral components around times 230 resulting in pulses 240, whereas the spectral components mostly interfere destructively at other times. Plot 200 shows the concept of “mode locking”. In mode-locked lasers, the phases of different spectral components lock to each other to form short pulses such as pulses of duration in the range from a few femtoseconds to tens of picoseconds. The shortest possible length of these pulses is given by the so called transform limit. When a pulse is transform limited, the pulse duration is as short as the spectral bandwidth permits. Generally, a pulse of duration less than approximately 10 times the transform limited pulse duration results from at least partial mode locking and thus some degree of correlated spectral phase.

Plot 202 shows the sum 260 of a plurality of spectral components, including spectral components 252, 254, and 256, having a random phase relationship. Sum 260 exhibit a seemingly random phase evolution although, since a finite number of spectral components contributed at a random but fixed relationship, the phase of sum 260 actually does evolve according to a repeating pattern. However, no pulses are formed, and the pattern would be different if the spectral components were restarted at a new set of random phases.

Plot 204 shows the sum 290 of a plurality of spectral components, including spectral components 272, 274, and 276, having a random phase relationship and further exhibiting occasional phase shifts exemplified by phase shifts 282, 284, and 286 of spectral components 272, 274, and 276, respectively. These phase shifts result in a re-scrambling of the phase relationship between the spectral components and sum 290 therefore does not exhibit a repeated pattern.

Referring again to FIG. 1, system 100 utilizes quasi-phase-matched frequency doubling to frequency double broadband laser light 122. Quasi-phase-matched frequency doubling, which is described in further detail below, has been established as a viable technique for frequency doubling over a broader spectral range. For example, crystals have been produced which are capable of frequency doubling a monochromatic laser beam of any single frequency within a certain bandwidth. Quasi-phase-matched frequency doubling has also been applied to the frequency doubling of broadband mode-locked laser pulses such as those illustrated by sum 220 in plot 200 of FIG. 2. However, system 100 implements a non-uniform period of domain-reversal to extend quasi-phase-matched frequency doubling to handle broadband light with uncorrelated spectral phase, that is, system 100 is capable of simultaneously frequency doubling several different spectral components having mutually uncorrelated spectral phases, such as the spectral components illustrated in plots 202 and 204 of FIG. 2. The spectral phases may further vary in time as illustrated in plot 204 of FIG. 2. By virtue of this capability, system 100 may generate frequency-doubled light 124 from broadband laser light 122 produced by any one of a host of different broadband laser systems, such as aggregated narrowband continuous-wave lasers of different frequencies, narrowband continuous-wave lasers spectrally broadened through four-wave mixing or other nonlinear process(es), a fiber laser, or a combination thereof. System 100 utilizes continuous-wave broadband laser light 122 or pulsed broadband laser light 122 that is not mode-locked. For example, the pulse duration of pulsed broadband laser light 122 may be greater than 10 times the transform limited pulse duration. In certain embodiments, system 100 includes one or more diode lasers to generate broadband laser light 122 (continuous wave or pulsed). Diode lasers are relatively low cost, have long life, and are essentially maintenance free.

System 100 may be used in a variety of applications requiring or benefitting from broadband light at wavelengths where broadband sources are either not available or are cost prohibitive. Digital cinema projectors is one such application. Coherent laser light projected onto a screen will produce the undesired effect of speckle, wherein light scattered by different points of the screen interfere and form a feature-rich interference pattern rather than a smooth image. If, on the other hand, the laser light projected onto the screen is incoherent or having only a relatively low degree of coherence, the interference between different scatter components will average out over a time scale that is faster than that discernible by human vision. A laser-based digital cinema projector therefore benefits from the laser light being incoherent or of low coherence. Since frequency-doubled light 124 generated by system 100 is broadband, frequency-doubled light 124 is relatively spectrally incoherent. Frequency-doubled light 124 is generally spatially coherent and has the form of a laser beam. However, spectral incoherence is sufficient to eliminated or reduce speckle. The degree of coherence of the frequency-doubled light 124 decreases with the bandwidth of frequency-doubled light 124. In one embodiment, system 100 is configured to generate frequency-doubled light 124 with a bandwidth corresponding to a speckle averaging time constant faster than that discernible by human vision. Human vision is generally capable of discerning only changes that happen at rates slower than 60 Hz. In one embodiment, system 100 is configured to generate frequency-doubled light 124 with a bandwidth corresponding to a speckle change rate greater than 60 Hz, such that the limitations of the human vision will average out the speckle. Other potential applications of system 100 include other laser-based lighting, laser machining, and laser-based projection for non-cinema settings.

In embodiments, system 100 includes a laser 120 and a frequency doubler 110. Frequency doubler 110 includes a domain-reversed grating 112 with a plurality of domains 114 arranged along the direction of light propagation through domain-reversed grating 112 (shown in FIG. 1 as light propagation direction 130). The orientation of each domain 114 is reversed as compared to its neighboring domains 114. For clarity of illustration, not all domains 114 are labeled in FIG. 1. Domain-reversed grating 112 is formed in a nonlinear optical material such as lithium tantalate, lithium niobate, or potassium titanyl phosphate (KTP), and each of these materials may be used in any one of the embodiments of domain-reversed grating 112 disclosed herein. Herein, domain reversal refers to the reversal of the nonlinear susceptibility tensor χ⁽²⁾. In one embodiment, the nonlinear optical material of domain-reversed grating 112 is ferroelectric and domains 114 are formed by poling the ferroelectric material with alternating poling orientation. In another embodiment, the nonlinear optical material of domain-reversed grating 114 is subjected to a spatially alternating electric field to form and maintain domains 114.

In operation, laser 120 emits a broadband laser beam 122 that contains a plurality of frequency components having uncorrelated spectral phase. One exemplary spectrum of broadband laser beam 122 is shown in plot 170. The spectrum of broadband laser beam 122 may be continuous as indicated by curve 172. Alternatively, the spectrum of broadband laser beam 122 is discrete as indicated by discrete spectral components 173, in which case curve 172 indicates the envelope of discrete spectral components 173. For clarity of illustration, only one spectral component 173 is labeled in FIG. 1. In embodiments, wherein the spectrum of broadband laser beam 122 is discrete, the spectrum of broadband laser beam may include any number of discrete spectral components 173, without departing from the scope hereof. In one example, the spectrum of broadband laser beam 122 includes between 2 and 200 spectral components 173.

Broadband laser beam 122 has center frequency f_{in,0} and bandwidth Δfᵢₙ. In one example, Δfᵢₙ is greater than 50 Gigahertz (GHz). In quasi-phase-matched frequency doubling in a conventional domain-reversed grating with constant poling period, the phase-matching bandwidth is inversely proportional to the length of the domain-reversed grating. 50 GHz is the typical upper limit for bandwidth achievable in a conventional domain-reversed grating having a length of a few centimeters and a constant poling period. However, by virtue of its non-uniform domain-reversal period, domain-reversed grating 112 is capable of achieving frequency doubling of broadband laser beam 122 having bandwidth Δfᵢₙ significantly greater than 50 GHz. In one example, bandwidth Δfᵢₙ is greater than 500 Gigahertz, such as around 1 Terahertz (THz) or a few THz, to enable frequency-doubling over these bandwidths.

Broadband laser beam 122 is directed into an input end 116 of domain-reversed grating 112 and propagates through domain-reversed grating 112 along light propagation direction 130, thus propagating through the series of domains 114. Domains 114 are configured for quasi-phase-matched frequency doubling of broadband laser beam 122 to form frequency-doubled light 124. Frequency-doubled light 124 has center frequency f_{SHG,0} and bandwidth Δf_{SHG}, wherein f_{SHG,0}≈2f_{in,0}, and Δf_{SHG}≈2Δfᵢₙ or less. The spectrum of broadband laser beam 122 is shown in plot 170. In embodiments, wherein the spectrum of broadband laser beam 122 is continuous, the spectrum of frequency-doubled light 124 may be continuous as well, as indicated by curve 174. In embodiments, wherein the spectrum of broadband laser beam 122 is discrete, the spectrum of frequency-doubled light 124 is discrete as well and includes a plurality of discrete spectral components 175. The number of spectral components 175 of frequency-doubled light 124 may be less than the number of spectral components 173 of broadband laser beam 122. In certain embodiments, Δf_{SHG} is sufficiently large that, when system 100 is implemented in a digital cinema projector, speckle may average out on a timescale faster than that discernible by human vision. For example, Δf_{SHG} may be 500 GHz or greater, such as around 1 THz or a few THz.

The reversal of domains 114 serves to reduce the phase mismatch between frequency doubled light formed at different spatial positions along light propagation direction 130. Generally, the index of refraction of the nonlinear optical material of domain-reversed grating 112 is a function of wavelength of the light propagating therein. Therefore, the propagation speed of frequency-doubled light 124 through the nonlinear optical material of domain-reversed grating 112 is generally different from the propagation speed of broadband light beam 122. Consequently, within each domain 114, frequency-doubled light 124 generated nearest input end 116 will not be exactly in phase with frequency-doubled light 124 generated nearest output end 118. This results in some degree of destructive interference between such components of frequency-doubled light 124. In the absence of domain-reversal, this phase mismatch would increase and result in an amount of destructive interference precluding generation of significant amounts of frequency-doubled light 124. However, the reversal of domains 114 flips the relationship of indices of refraction between broadband laser beam 122 and frequency-doubled light 124 to at least approximately reverse the accumulated phase mismatch, thereby reducing the destructive interference and instead promoting constructive interference. This is the mechanism known as quasi-phase-matched frequency doubling. The period of domain reversal of domain-reversed grating 112, as achieved by domains 114, is configured to reduce the destructive interference so as to produce significant amounts of frequency-doubled light 124.

In a conventional quasi-phase-matching crystal configured to frequency-double light at a single fundamental frequency, it is relatively simple to find one constant period of domain-reversal that is suitable for quasi-phase-matching at this single frequency. In another conventional quasi-phase-matching crystal, configured to frequency-double broadband mode-locked light, the fixed, correlated phase relationship between different frequency components simplifies the requirements to the crystal. However, this conventional design relies on the fixed and correlated phase relationship between the different frequency components to achieve quasi-phase-matched frequency doubling.

In contrast, broadband laser beam 112 has frequency components with uncorrelated phases and the conventional designs do not apply. Instead, domain-reversed grating 112 relies on a non-uniform period of domains 114 specifically configured to achieve efficient frequency doubling for broadband laser beam 122 across the full bandwidth Δfᵢₙ of broadband laser beam 122, across the majority of bandwidth Δfᵢₙ of broadband laser beam 122, or across a significant fraction of bandwidth Δfᵢₙ. For each different embodiment of broadband laser beam 122, domain-reversed grating 112 may be implemented with a respective configuration of domains 114 specifically tailored to frequency double this particular embodiment of broadband laser beam 122. FIG. 1 shows exemplary periods 132 of domain-reversal of domain-reversed grating 112. The value of period 132 varies along light propagation direction 130, for example with a period 132(1) in one portion of domain-reversed grating 112 being smaller than period 132(2) in another portion of domain-reversed grating 112. Period 132 is, for example, in the range from one to tens of micrometers. It is understood that the periodicity shown in FIG. 1 is only one example and that domain-reversed grating 112 may be configured with a different periodicity and/or with fewer or more domains 114 than shown in FIG. 1, without departing from the scope hereof.

Without departing from the scope hereof, frequency-doubler 110 or domain-reversed grating 112 may be supplied as a stand-alone item configured to cooperate with a third party laser 120.

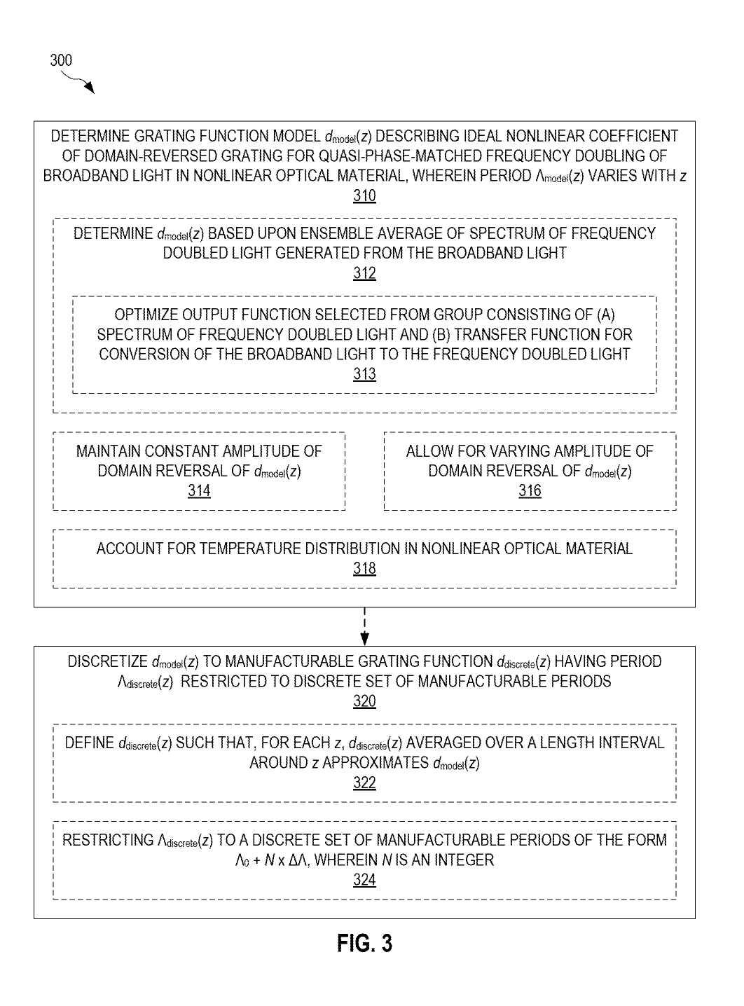

FIG. 3 illustrates one exemplary method 300 for designing a domain-reversed grating for quasi-phase-matched frequency doubling of broadband laser light with uncorrelated spectral phase. “Frequency doubling” is commonly referred to in the art as “second harmonic generation” (SHG). Method 300 may be used to design domain-reversed grating 112 for different types of broadband laser beams 122 and according to one or more of a variety of desired properties of domain-reversed grating 112 and/or frequency-doubled light 124. For example, method 300 may design an embodiment of domain-reversed grating 112 capable of producing frequency-doubled light 124 of certain desired properties, given predefined properties of broadband laser beam 122. Exemplary desired properties of frequency-doubled light 124 include the power of frequency-doubled light 124, the bandwidth of frequency-doubled light 124, and flatness of the spectral profile of frequency-doubled light 124.

In a step 310, method 300 determines a grating function model d_{model}(Z) that describes an ideal nonlinear coefficient χ⁽²⁾ of a domain-reversed grating, for quasi-phase-matched frequency doubling of broadband input light in a nonlinear optical material, as a function of position z along the light propagation direction through the nonlinear optical material. The period Λ_{model}(Z) of the modeled grating function d_{model}(Z) exhibits variation as a function of z. Herein “ideal” may refer to a single optimal instance of d_{model}(Z) or an instance of d_{model}(Z) deemed suitable for achieving one or more predefined design goals. Thus, in certain embodiments, each of several different instances of d_{model}(Z) may be a suitable output of step 310, without departing from the scope hereof. The grating model d_{model}(Z) determined in step 310 may or may not be manufacturable. For example, the period of domain-reversal of d_{model}(Z) may be a continuous function of z even though manufacturing of a domain-reversed grating typically is subject to discrete manufacturing resolutions. In one example of step 310, method 300 determines a grating function model Λ_{model}(z) that describes an ideal, but not necessarily manufacturable, nonlinear coefficient of an embodiment of domain-reversed grating 112, for quasi-phase-matched frequency doubling of an embodiment of broadband laser beam 122 in the nonlinear optical material of domain-reversed grating 112, as a function of position z along light propagation direction 130 through domain-reversed grating 112.

In a subsequent step 320, method 300 discretizes d_{model}(Z) to a manufacturable grating function d_{discrete}(Z) having period Λ_{discrete}(Z) restricted to a discrete set of manufacturable periods. In one example of step 320, method 300 discretizes a grating function model d_{model}(Z) determined for quasi-phase-matched frequency doubling of an embodiment of broadband laser beam 122 in the nonlinear optical material of an embodiment of domain-reversed grating 112.

Referring again to step 310, in one embodiment, step 310 implements a step 312 of determining d_{model}(Z) based upon the ensemble average of the spectrum of frequency doubled light generated from the broadband input light. Without being bound by theory, the following is a discussion of the theory behind this ensemble-average based step 312:

For broadband frequency doubling of broadband input light, the output spectrum of the frequency-doubled light may be estimated as A_{SHG}(Ω)=D(Ω)A_{NL}(Ω), wherein Ω is the angular frequency detuning from the carrier frequency (e.g., f_{SHG,0}), D(Ω) is the transfer function, and A_{NL}(Ω) is the self-convolution of the spectrum of the broadband input light A_{NL}(Ω)=∫_{-∞}^{∞}Aᵢₙ(Ω′)Aᵢₙ(Ω−Ω′)dΩ′, wherein Aᵢₙ(Ω) is the spectrum of the broadband input light. Assuming plane waves, undepleted pump (that is, undepleted broadband input light), and no dispersion beyond the ground velocity mismatch between the broadband input light and the frequency-doubled light, the spectral intensity I_{SHG}(Ω)=|A_{SHG}(Ω)|² of the frequency-doubled light may then be obtained as I_{SHG}(Ω)=|D(Ω)|²I_{NL}(Ω), wherein I_{NL}(Ω)=|A_{NL}(Ω)|². Since the broadband input light has uncorrelated spectral phase, the self-convolution A_{NL}(Ω) of the broadband input light is likely a strong function of time with the variations being on a fast time scale (akin that shown in plots 202 and 204 for sums 260 and 290, respectively). Hence, the frequency spectrum A_{SHG}(Ω) of the frequency-doubled light is also likely a strong function of time with variations being on a fast time scale, e.g., faster than Terahertz timescales. These variations are important in the mode-locked regime (see plot 200 of FIG. 2). However, when operating with broadband input light of uncorrelated spectral phase, these variations primarily result in noise-like behavior on time scales exceeding human perception. Therefore, the present theory instead utilizes the ensemble average of the power spectrum [symbol] I_{NL}(Ω) [symbol] of the broadband input light. Using this ensemble average, the ensemble average of the frequency-doubled light may then be estimated as [symbol] I_{SHG}=(Ω) [symbol] =|D(Ω)|² [symbol] I_{NL}(Ω) [symbol] , wherein [symbol] I_{NL}(Ω) [symbol] =2f_{-∞}^{∞}Iᵢₙ(Ω′)Iᵢₙ(Ω−Ω′)dΩ′, wherein Iᵢₙ(Ω)=|Aᵢₙ(Ω)|². It is noted that [symbol] I_{NL}(Ω) [symbol] is not the same as I_{NL}(Ω), and hence, even though the transfer function D(Ω) is the same in the preceding field treatment as in the present ensemble average treatment, the ensemble average treatment is different from the field treatment. The field treatment is appropriate when the field of the input light is known and of correlated (static) phase. However, the ensemble average treatment is appropriate for the present scenario where the broadband input light has uncorrelated (non-static) spectral phase.

Proceeding with the ensemble average treatment, for a given input spectrum [symbol] Iᵢₙ(Ω) [symbol] and a target ensemble average [symbol] I_{SHG}(Ω) [symbol] of the output spectral intensity, the target transfer function fulfills |D(Ω)|²= [symbol] I_{SHG}(Ω) [symbol] / [symbol] I_{NL}(Ω) [symbol] . Achieving such a transfer function is equivalent to quasi-phase-matching through a grating function d(z) defining the nonlinear coefficient along the light propagation direction z. The grating function d(z) is related to D(Ω) through a Fourier transform. However, in many cases, the inverse Fourier transform of a target D(Ω) results in a complex d(z) with both amplitude and phase being non-uniform functions of z. In certain embodiments of step 312, the grating function model is approximated as d_{model}(z)=|d(z)|e^{iϕ}^{_{g}}^{(z)} such that the phase of the grating function model d_{model}(z) is approximated as ϕ_{g}(z) to achieve a transfer function close to the target transfer function D(Ω).

Step 312 includes a step 313 of optimizing an output function that is either the spectral intensity I_{SHG}(Ω) of the frequency-doubled light or the transfer function D(Ω) for conversion of the broadband input light to frequency-doubled light. In one example, step 313 utilizes the relationships |D(Ω)|²= [symbol] I_{SHG}(Ω) [symbol] / [symbol] I_{NL}(Ω) [symbol] and d_{model}(z)=|d(z)|e^{iϕ}^{_{g}}^{(z)} to determine d_{model}(z) for an embodiment of domain-reversed grating 112 based upon a known spectrum Aᵢₙ(Ω) for broadband laser beam 122 and a target spectral intensity I_{SHG}(Ω) for frequency-doubled light 124. In another example, step 313 determines d_{model}(z) for an embodiment of domain-reversed grating 112 based upon a target transfer function D(Ω) for conversion of broadband laser beam 122 to frequency-doubled light 124 and the relationship d_{model}(z)=|d(z)|e^{iϕ}^{_{g}}^{(z)}. In either one of these two embodiments, step 313 may optimize the spectral intensity I_{SHG}(Ω) or the transfer function D(Ω) based upon a selection of candidate gratings.

Step 310 includes either a step 314 of maintaining a constant amplitude of domain reversal of d_{model}(z) or a step 316 of allowing a varying amplitude of the domains of d_{model}(Z). Step 314 may utilize a further restricted relationship d_{model}(Z)=d_{eff}e^{iϕ}^{_{g}}^{(z)}, wherein d_{eff} is a constant. In one example of step 310 implementing step 314, step 310 determines a grating function model d_{model}(z), with domains of constant amplitude, for an embodiment of domain-reversed grating 112. In one example of step 310 implementing step 316, step 310 allows for domains of varying effective amplitude of the grating function model d_{model}(z) for an embodiment of domain-reversed grating 112. Throughout this disclosure, when considering embodiments of a domain-reversed grating wherein the domain reversal is achieved by poling, the effective amplitude of the grating function is related to the material nonlinearity and the duty cycle of the poling.

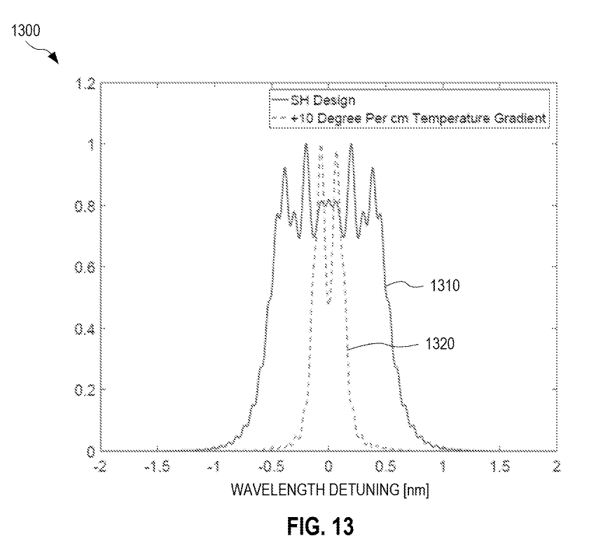

In embodiments, step 310 further implements a step 318 of accounting for the temperature distribution of the nonlinear optical material of the domain-reversed grating. As will be discussed in further detail below in reference to FIG. 13, the temperature gradient in the nonlinear optical material of the domain-reversed grating may greatly affect the nature of quasi-phase-matched frequency doubling in the domain-reversed grating. The temperature distribution depends on several parameters, including the spatial power distribution of the broadband input light, the spatial power distribution of the frequency-doubled light, the absorption coefficient for absorption of the broadband input light in the nonlinear optical material, and the absorption coefficient for absorption of the frequency-doubled light in the nonlinear optical material. Temperature effects are particularly important when operating at high power of the broadband input light, such as high power of broadband laser beam 122, since high-power input light as well as frequency doubled light generated therefrom may deposit a significant amount of energy into the non-linear optical material through both linear and nonlinear absorption effects. Although not shown in FIG. 3, step 310 may also account for diffraction effects in the nonlinear optical material, as well as for variations in beam diameter/size as a function of position z along the light propagation direction, without departing from the scope hereof.

Step 320 may include a step 322 of defining d_{discrete}(Z) such that, for each position z along the light propagation direction, d_{discrete}(z) averaged over a length interval around z approximates d_{model}(Z). In one example, step 322 discretizes d_{model}(z), determined for an embodiment of domain-reversed grating 112, such that, for each position z along light propagation direction 130, d_{discrete}(z) averaged over a length interval around z approximates d_{model}(Z).

In certain embodiments, step 320 implements a step 324 of restricting the period Λ_{discrete}(Z) to a set of manufacturable periods of the form Λ₀+N·ΔΛ, wherein N is an integer, and wherein Λ₀ and N cooperate to ensure that Λ_{discrete}(z) is positive. The value of Λ₀ may be zero or non-zero.

In embodiments, method 300 may be implemented as a software product, possibly in the form of machine-readable instructions encoded in transitory and/or volatile memory, and/or non-transitory and/or non-volatile memory. These instructions may be executed by a processor so as to perform method 300.

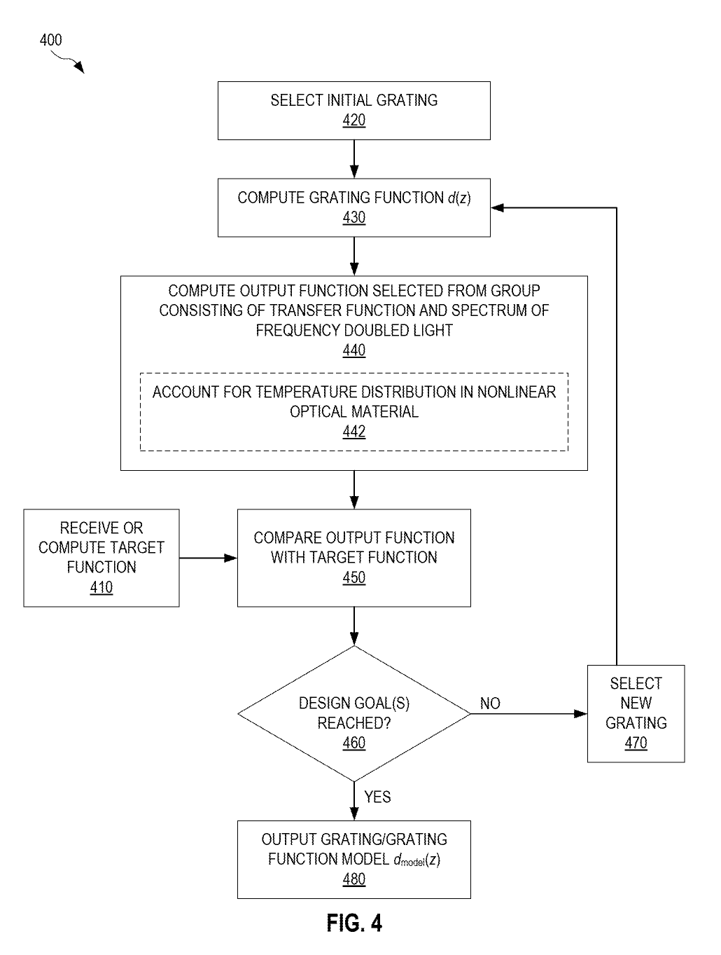

FIG. 4 illustrates one exemplary method 400 for iteratively determining grating function model d_{model}(Z). Method 400 is an embodiment of step 310 of method 300, implementing step 312, and may be used to determine a grating function model d_{model}(z) for an embodiment of domain-reversed grating 112.

In a step 410, method 400 receives or computes a target function. The target function is either a target transfer function D(Ω) (or |D(Ω)|²) for the grating design of method 400 or a target ensemble average [symbol] I_{SHG}(Ω) [symbol] of the output spectral intensity of the frequency-doubled light to be generated from a grating according to this design and assuming broadband input light having a predefined spectral intensity Iᵢₙ(Ω). In one example, step 410 receives a target transfer function D(Ω) (or |D(Ω)|²) for a desired embodiment of domain-reversed grating 112, or a target ensemble average [symbol] I_{SHG}(Ω) [symbol] of the output spectral intensity of frequency-doubled light 124 sought to be generated from broadband laser beam 122 having known spectral intensity Iᵢₙ(Ω). Without departing from the scope hereof, the target output function may be only partly characterized. For example, instead of receiving or computing a fully characterized target transfer function, step 410 may receive or compute one or more figures of merit related to the target ensemble average [symbol] I_{SHG}(Ω) [symbol] of the output spectral intensity of the frequency-doubled light. Exemplary figures of merit include the bandwidth of the frequency-doubled light (e.g., greater than 500 GHz or greater, such as around 1 THz or a few THz), the power of the frequency-doubled light, and the flatness of the spectral profile of the frequency-doubled light (e.g., peak-to-peak fluctuations of the spectral intensity envelope of the frequency-doubled light being no greater than 50% of the average value of the spectral intensity envelope of the frequency-doubled light within the bandwidth). Likewise, step 410 may receive or compute one or more figures of merit related to the transfer function D(Ω), such as the conversion efficiency for conversion of the broadband input light to frequency-doubled light.

A step 420 selects an initial grating design. In one example of step 420, method 400 is concerned with determining a grating function model for domain-reversed grating 112 assuming certain properties of broadband laser beam 122, and step 420 makes a first prediction at a grating design suitable to achieve one or more desired properties of domain-reversed grating 112 and/or frequency-doubled light 124. Step 420 may select a grating characterized by a constant amplitude of the domains of the associated grating function. Alternatively, step 420 may select a grating characterized by a non-uniform amplitude of the domains of the associated grating function.

A subsequent step 430 computes the grating function d(z) for the grating design currently under consideration. In the first iteration of step 430, step 430 computes the grating function d(z) for the grating design selected in step 420. In subsequent iterations of step 430, step 430 computed the grating function d(z) for a grating selected in a step 470 discussed below. In one example, step 430 computes the grating function d(z) for a candidate grating design for an embodiment of domain-reversed grating 112.

A step 440 computes an output function that is either the transfer function D(Ω) (or |D(Ω)|²) and/or the ensemble average [symbol] I_{SHG}(Ω) [symbol] of the output spectral intensity of the frequency-doubled light assuming broadband input light having a predefined spectral intensity Iᵢₙ(Ω). Step 440 utilizes the ensemble average treatment discussed above in reference to step 312 of method 300 and performs the computation(s) based upon the grating function d(z) computed in step 430. The transfer function D(Ω) (or |D(Ω)|²) is computed from a Fourier transform of the grating function d(z) computed in step 430. Computation of the ensemble average [symbol] I_{SHG}(Ω) [symbol] further includes application of the relationship |D(Ω)|²= [symbol] I_{SHG}(Ω) [symbol] / [symbol] I_{NL}(Ω) [symbol] . In one example, step 440 computes the transfer function D(Ω) (or |D(Ω)|²) of the candidate grating design for an embodiment of domain-reversed grating 112, or the ensemble average [symbol] I_{SHG}(Ω) [symbol] of the output spectral intensity of frequency-doubled light 124 generated from an embodiment of broadband laser beam 122 in an embodiment of domain-reversed grating 112 according the candidate grating design currently under consideration. Step 440 may include a step 442 of accounting for the temperature distribution in nonlinear optical material. Although not shown in FIG. 4, step 440 may also account for diffraction effects in the nonlinear optical material, as well as for variations in beam diameter/size as a function of position z along the light propagation direction, without departing from the scope hereof. Also without departing from the scope hereof, the output function determined in step 440 may be only partly characterized, for example by one or more figures or merit as discussed above in reference to step 410.

A step 450 compares the output function computed in step 440 to the corresponding target function received or computed in step 410. In one example, step 450 compares a transfer function D(Ω) (or |D(Ω)|²) determined in step 440 to a corresponding target transfer function received or computed in step 410 and pertaining to a desired embodiment of domain-reversed grating 112. In another example, step 440 compares an ensemble average [symbol] I_{SHG}(Ω) [symbol] computed in step 440 to a corresponding target ensemble average of the output spectral intensity of frequency-doubled light 124 sought to be generated from broadband laser beam 122 having known spectral intensity Iᵢₙ(Ω). In embodiments of method 400, wherein one or both of the output function computed in step 440 and the target function computed or received in step 410 is only partly characterized by one or more figures of merit, step 450 compares the available figures of merit instead of fully characterized functions.

A subsequent step 460 evaluates if one or more design goals have been reached. Exemplary design goals include figures of merit related to one or both of the transfer function D(Ω) (or |D(Ω)|²) and the [symbol] I_{SHG}(Ω) [symbol] of the output spectral intensity of the frequency-doubled light, such as the figures of merit discussed above in reference to step 410.

If step 460 determines that the one or more design goals have not been reached, method 400 proceeds to a step 470. Step 470 selects a new grating design based upon an optimization algorithm and inputs this grating to step 430, to perform another iteration of steps 430, 440, 450, and 460. The optimization algorithm used in step 470 may be a gradient based search or a population based optimization. In the population based optimization, each iteration of method steps 430, 440, 450, and 460 considers a population of gratings. Examples of optimization algorithms that may be utilized in step 430 include nonlinear optimization, genetic algorithm, and simulated annealing.

If on the other hand, step 460 determines that the one or more design goals have been reached, method 400 proceeds to a step 480 that outputs, as the grating function model d_{model}(z), the grating function d(z) for the grating currently under consideration. Step 480 may also output the actual grading design underlying the grating function model d_{model}(z). Given the iterative nature of method 400, step 460 may further consider one or more design goals related to the iterative process. For example, step 460 may require some degree of convergence of the iterations toward a consistent grating design before proceeding to step 480.

In one embodiment, the design goals evaluated in step 460 also include the manufacturability of the grating design, wherein the associated design goal would be a requirement that the grating design may be discretized in step 320 of method 300 to produce a manufacturable grating function d_{discrete}(Z). In another embodiment, grating designs available for selection in steps 420 and 470 are limited to grating designs that may be discretized in step 320 of method 300 to produce a manufacturable grating function d_{discrete}(Z). In one such example, the grating designs available for selection in steps 420 and 470 are characterized by a polynomial Λ_{model}(Z) of fourth degree or less.

In embodiments, method 400 may be implemented as a software product, for example in the form of machine-readable instructions encoded in transitory and/or volatile memory, and/or non-transitory and/or non-volatile memory. These instructions may be executed by a processor so as to perform method 400.

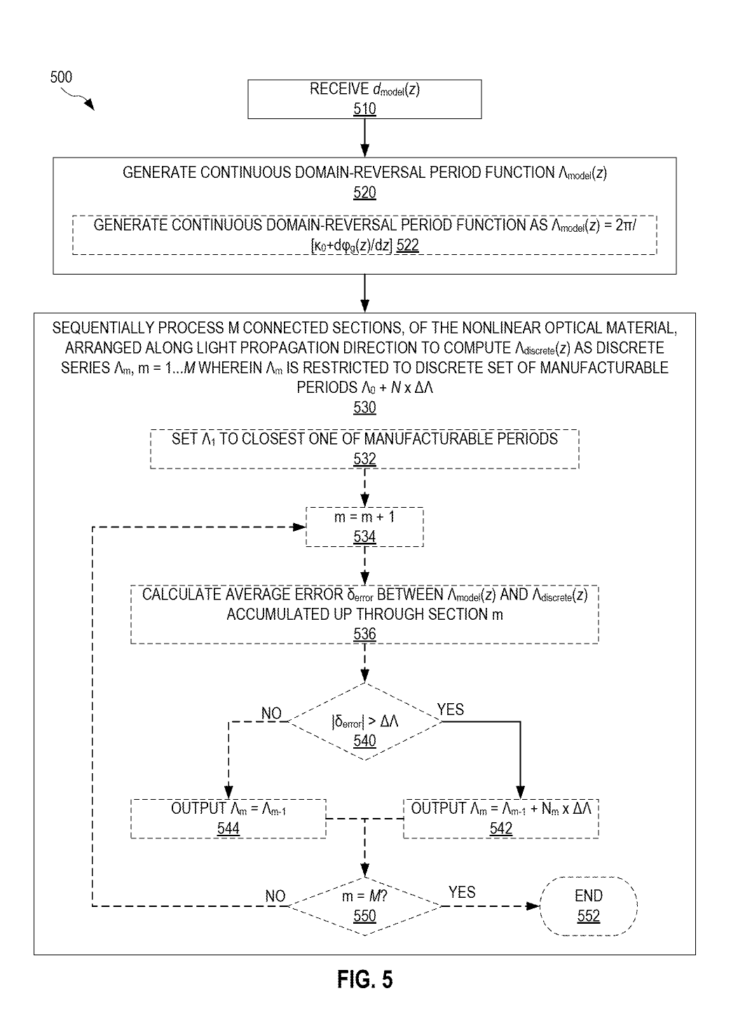

FIG. 5 illustrates one exemplary method 500 for discretizing grating function model d_{model}(Z) to a manufacturable grating function d_{discrete}(Z) having period Λ_{discrete}(Z) restricted to a discrete set of manufacturable periods. Method 500 is an embodiment of step 320, and may be used to determine a manufacturable grating function d_{discrete}(Z) for an embodiment of domain-reversed grating 112. In certain embodiments, method 500 accepts, as input, a grating function model d_{model}(z) determined by method 400.

In a step 510, method 500 receives a grating function model d_{model}(z), for example describing an ideal nonlinear coefficient χ⁽²⁾ for domain-reversed grating 112, for quasi-phase-matched frequency doubling of broadband laser beam 122, as a function of position z along light propagation direction 130 through the nonlinear optical material of domain-reversed grating 112. Step 510 may receive the grating function model d_{model}(z) from step 480 of method 400.

A step 520 processes the grating function model d_{model}(z) received in step 510 to generate a continuous domain-reversal period function Λ_{model}(z). The continuous domain-reversal period function Λ_{model}(z) is a continuous function of z and describes an ideal periodicity of domain reversal within the domain-reversed grating. In one example, step 520 generates a continuous domain-reversal period function Λ_{model}(z) for a grating function model d_{model}(z) pertaining to an embodiment of domain-reversed grating 112. In embodiments, step 520 includes a step 522 of calculating the continuous domain-reversal period function as

$${Λ}_{model} ( z ) = 2 π / [ {κ}_{0} + \frac{d {ϕ}_{g} ( z )}{dz} ] ,$$

wherein κ₀ is the carrier wave vector for the domain reversal. κ₀ may be calculated as the wave vector of domain reversal required for phase matching at the center frequency of the spectrum, e.g., at f_{in,0} of broadband laser beam 122 or f_{SHG,0} of frequency-doubled light 124.

A subsequent step 530 segments the domain-reversed grating into M sections arranged along the light propagation direction, and sequentially processes the M sections to compute Λ_{model}(z) as a discrete series of periods Λₘ, m=1 . . . M, wherein M is an integer greater than one. Periods Λₘ are restricted to a discrete set of manufacturable periods of the form Λ₀+N·ΔΛ discussed above in reference to step 324, and the period Λₘ is constant within each of the M sections. ΔΛ may be in the range from around one to tens of micrometers. In one example, step 530 segments domain-reversed grating 112 into M sections arranged along light propagation direction 130, and sequentially processes the M sections along light propagation direction 130 starting from input end 116 to determine Λₘ for each of the sections. This series of periods Λₘ defines period 132 for each of the sections.

In an embodiment, step 530 implements an algorithm including steps 532, 534, 536, 540, 542, 544, 550, and 552 to determine the periods Λₘ.

In step 532, the period Λ₁ of the first one of the sections closest the input end is set to the one of the manufacturable periods Λ₀+N·ΔΛ closest to the average value of the continuous period Λ_{model}(z) within the first section.

Step 534 increments the value of m by one.

Step 536 calculates the average error δₑᵣᵣₒᵣ between Λ_{discrete}(z) and Λ_{model}(Z) accumulated up through the section currently under consideration, assuming that the section currently under consideration has same period Λₘ as the preceding section. In one embodiment, each of the M sections has the same extent Δz along the light propagation direction, and the average error is calculated as

$${δ}_{error} = \frac{1}{Δ z} {\sum }_{i = 1}^{m} {\int }_{{z}_{i}}^{{z}_{i + 1}} ( {Λ}_{model} ( z ) - {Λ}_{discrete} ( z ) ) dz ,$$

wherein zᵢ is the position of the start of section m.

Step 540 evaluates if the magnitude of δₑᵣᵣₒᵣ exceeds ΔΛ. If the magnitude of δₑᵣᵣₒᵣ does not exceed ΔΛ, method 500 proceeds to step 544 which sets Λₘ to the same value as that of the preceding section. If, on the other hand, δₑᵣᵣₒᵣ exceeds ΔΛ, method 500 proceeds to step 542 which increases or decreases (depending on the sign of δₑᵣᵣₒᵣ) the period Λₘ by Nₘ·ΔΛ, wherein Nₘ is such that Nₘ·ΔΛ most closely approximates δₑᵣᵣₒᵣ In embodiments, the extent Δz of each of the M sections is set sufficiently small that step 542 never needs to increase or decrease the period Λₘ by more than ΔΛ.

After the performance of steps 542 or 544, method 500 proceeds to a step 550 which evaluates if the last one of the M sections has been processed. If so, method 500 proceeds to a step 552 of ending the algorithm. Otherwise, method 500 returns to step 534 to initiate processing of the next one of the M sections.

In embodiments, method 500 may be implemented as a software product, for example in the form of machine-readable instructions encoded in transitory and/or volatile memory, and/or non-transitory and/or non-volatile memory. These instructions may be executed by a processor so as to perform method 500

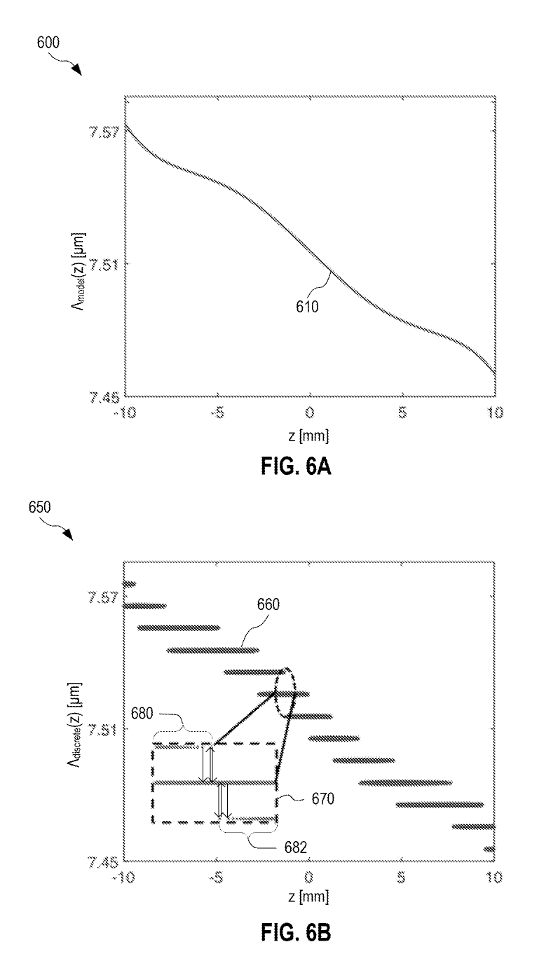

FIG. 6A shows one exemplary continuous domain-reversal period function Λ_{model}(z) determined by method 400 for one embodiment of domain-reversed grating 112 having a length of 2 centimeters. FIG. 6B shows a corresponding discretized domain-reversal period function Λ_{discrete}(Z) for this embodiment of domain-reversed grating 112, which is determined by method 500 implementing steps 532 through 552, and wherein ΔΛ is approximately 10 nanometers. FIGS. 6A and 6B are best viewed together.

Λ_{model}(Z) (curve 610) decreases in a nonlinear fashion as a function of position z. Since Λ_{discrete}(Z) (curve 660) is restricted to a discrete set of manufacturable values, the value of Λ_{discrete}(Z) is generally different from the value of Λ_{model}(Z). In regions where Λ_{discrete}(Z) differs from Λ_{model}(z), Λ_{discrete}(Z) approximates Λ_{model}(Z) by alternating the period Λₘ between the two values of the manufacturable periods that are just above and just below, respectively, the value of Λ_{model}(z). In regions where Λ_{model}(z) is closer to the manufacturable period just above the value of Λ_{model}(z), the number of sections having Λ_{discrete}(Z) set to the manufacturable period just above the value of Λ_{model}(z) is greater than the number of sections having Λ_{discrete}(z) set to the manufacturable period just below the value of Λ_{model}(Z), and vice versa. This alternating behavior ensures that Λ_{discrete}(z), averaged over a region around each position z, approximates the value of Λ_{model}(z) at this position z. This alternating behavior is more clearly displayed in close-up 670 showing Λ_{discrete}(z) for a portion of this embodiment of domain-reversed grating 112. In a region 680, Λ_{discrete}(z) alternates between periods of 7.35 micrometers and 7.25 micrometers. At the beginning of a neighboring region 682, the value of Λ_{model}(z) drops below 7.25 micrometers, and Λ_{discrete}(z) instead alternates between periods of 7.25 micrometers and 7.15 micrometers.

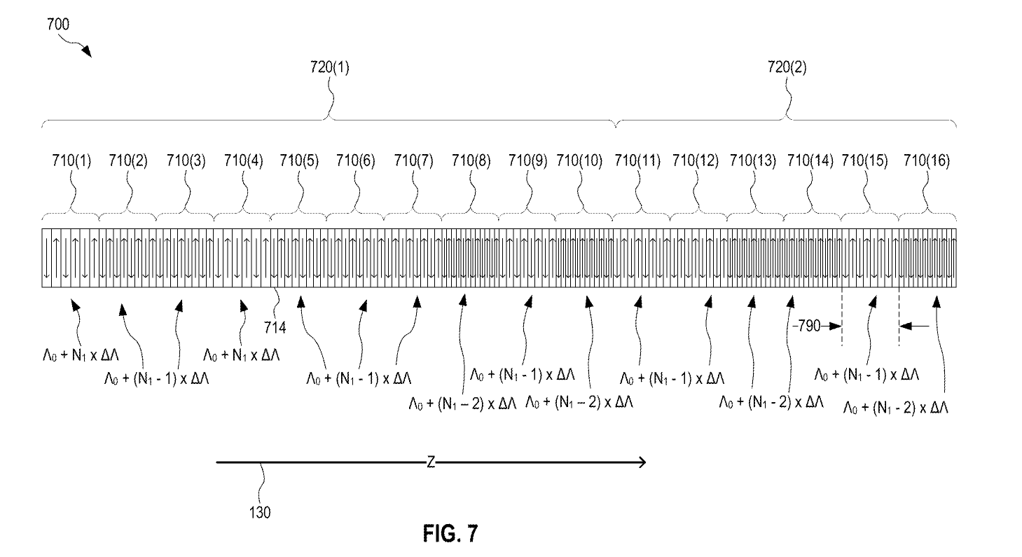

FIG. 7 schematically illustrates one exemplary domain-reversed grating 700 having a non-uniform domain-reversal period. Domain-reversed grating 700 is an embodiment of domain-reversed grating 112 and may be designed using method 300 implementing steps 322 and 324 and, in embodiments, also implementing one of both of methods 400 and 500.

Domain-reversed grating 700 is segmented into sections 710 arranged along light propagation direction 130. Sections 710 are examples of the M sections used in method 500. Each section 710 includes a plurality of domains 714, and throughout domain-reversed grating 700, the orientation of domains is repeatedly reversed. Each section 710 has extent 790 (Δz), which is in the range from tens to hundreds of micrometers. Domains 714 are embodiments of domains 114. For clarity of illustration, not all domains 714 are labeled in FIG. 7. Within each section 710, the domain-reversal period of domain-reversed grating 700 is constant and restricted to manufacturable periods of the form Λ₀+N·ΔΛ discussed above in reference to 324. In a first portion 720(1), the period of domain-reversed grating 700 alternates between Λ₀+N₁·ΔΛ and Λ₀+(N₁−1)·ΔΛ. In a subsequent and adjacent portion 720(2), the period of domain-reversed grating 700 alternates between Λ₀+(N₁−1)·ΔΛ and Λ₀+(N₁−2)·ΔΛ. The amplitude of domains 714 may be a constant or varying function of the position z along light propagation direction 130. Without departing from the scope hereof, domain-reversed grating 700 may contain more or fewer domains 714 and/or sections 710 than shown in FIG. 7.

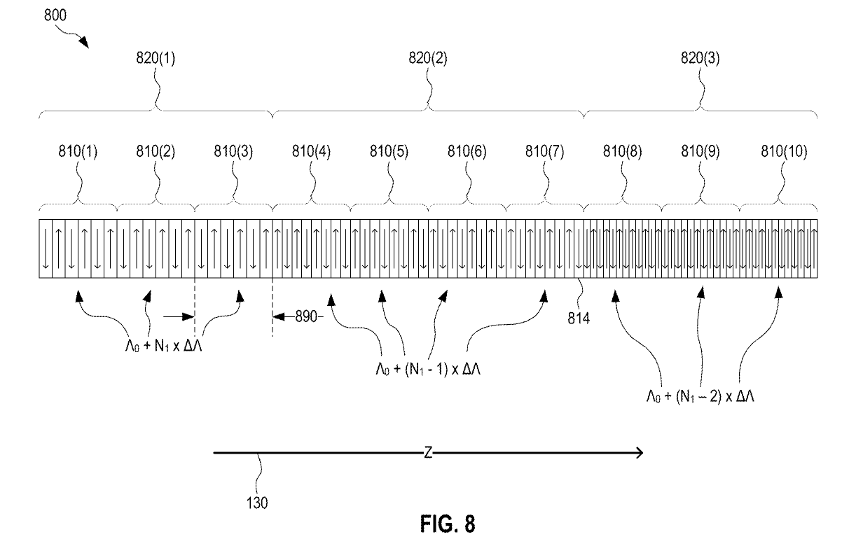

FIG. 8 schematically illustrates another exemplary domain-reversed grating 800 having a non-uniform domain-reversal period. Domain-reversed grating 800 is an embodiment of domain-reversed grating 112 and may be designed using method 300 implementing steps 322 and 324, and in embodiments also implementing one of both of methods 400 and 500.

Domain-reversed grating 800 is similar to domain-reversed grating 700 except for the domain-reversal period not exhibiting the alternating behavior shown in FIG. 7. Domain-reversed grating 800 is segmented into sections 810 arranged along light propagation direction 130. Sections 810 are examples of the M sections used in method 500. Each section 810 includes a plurality of domains 814, and throughout domain-reversed grating 800, the orientation of domains is repeatedly reversed. Each section 810 has extent 890 (Δz), which is in the range from tens to hundreds of micrometers. Domains 814 are embodiments of domains 114. For clarity of illustration, not all domains 814 are labeled in FIG. 8. Within each section 810, the domain-reversal period of domain-reversed grating 700 is constant and restricted to manufacturable periods of the form Λ₀+N·ΔΛ discussed above in reference to 324. In a first portion 820(1), the period of domain-reversed grating 800 is Λ₀+N₁·ΔΛ. In a subsequent and adjacent portion 820(2), the period of domain-reversed grating 800 is Λ₀+(N₁−1)·ΔΛ. In a subsequent portion 820(3) adjacent to portion 820(2), the period of domain-reversed grating 800 is Λ₀+(N₁−2)·ΔΛ. The amplitude of domains 814 may be a constant or varying function of the position z along light propagation direction 130. Without departing from the scope hereof, domain-reversed grating 800 may contain more or fewer domains 814 and/or sections 810 than shown in FIG. 8. In addition, the period may be a non-monotonic function of the position z along light propagation direction 130, without departing from the scope hereof. For example, portion 820(2) may be characterized by period Λ₀+(N₁−2)·ΔΛ, and portion 820(3) be characterized by period Λ₀+(N₁−1)·ΔΛ.

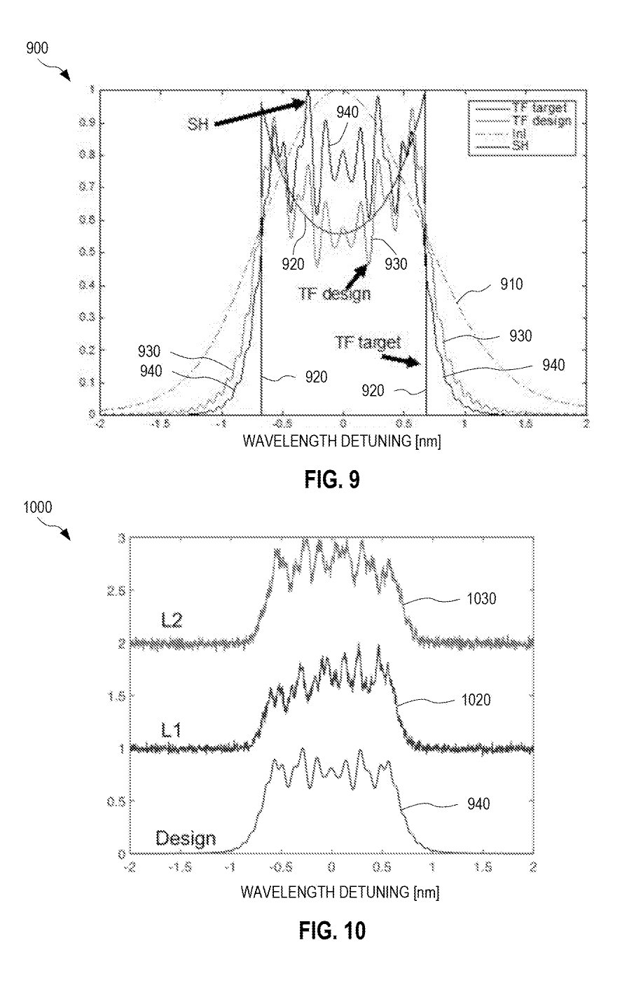

FIG. 9 shows exemplary design results for one embodiment of domain-reversed grating 112. The results of FIG. 9 are achieved using method 300, implementing both method 400 and method 500.

Curve 910 is the ensemble average [symbol] I_{NL}(Ω) [symbol] of one embodiment of broadband laser beam 120. Curve 920 is a target transfer function |D(Ω)|² received in step 410 of method 400. This target transfer function has a concave spectral profile to compensate for the peaked profile of the ensemble average [symbol] I_{NL}(Ω) [symbol] of the input broadband laser beam. Curve 930 is the output transfer function |D(Ω)|² generated in step 440 and pertaining to the grating function model d_{model}(Z) determined by method 400 and outputted by step 480. While the output transfer function |D(Ω)|² (curve 930) has oscillations not present in the target transfer function |D(Ω)|² (curve 920), the output transfer function resembles the target transfer function. In particular, the output transfer function |D(Ω)|² (curve 930) has a concave spectral profile with a bandwidth similar to that of the target transfer function |D(Ω)|² (curve 920). The resulting calculated ensemble average [symbol] I_{SHG}(Ω) [symbol] of the frequency-doubled light, an example of frequency-doubled light 124, is plotted as curve 940. All of curves 910, 920, 930, and 940 are plotted in arbitrary units as a function of the wavelength detuning in nanometers (nm) from the center wavelength. The ensemble average [symbol] I_{SHG}(Ω) [symbol] of the frequency-doubled light has a spectral bandwidth of approximately 1.4 nm and exhibits a flat-top-like profile with modulations superimposed thereon. The peak-to-peak fluctuations are less than 50% of the average intensity of the frequency-doubled light within the bandwidth. It is understood that the peak-to-peak fluctuations pertain to the envelope of the spectrum of the frequency-doubled light, even though the spectrum of the frequency-doubled light may be at least partly composed of discrete spectral components spectrally spaced apart from each other. The 1.4 nm bandwidth in wavelength space corresponding to a ˜1.5 THz bandwidth in frequency space for a center frequency of the frequency doubled light is in the green portion of the spectrum. Combined with the relative flatness of the spectral profile, this bandwidth is an example of excellent broadband frequency-doubling. In particular, a domain-reversed grating with these performance properties is suitable for avoiding generation of speckle discernible by human vision in a scenario where the domain-reversed grating is used in a digital cinema projector.

FIG. 10 shows actual measurements of the spectral intensity profile of frequency-doubled light 124 generated in two different domain-reversed gratings. Each of these two gratings are designed according to output transfer function |D(Ω)|² (curve 930) of FIG. 9, with the period of domain reversal being discretized using method 500, and the measurements are made with broadband laser beam 120 having a spectral profile similar to that shown in curve 910. Curve 1020 shows the measured spectral intensity profile for one of the domain-reversed gratings and curve 1030 shows the measured spectral intensity profile for the other one of the domain-reversed gratings. For comparison, the calculated ensemble average [symbol] I_{SHG}(Ω) [symbol] of the frequency-doubled light (curve 940) is depicted in FIG. 10 as well. The curves are offset for clarity. While the measured spectra 1020 and 1030 are not identical to the calculated spectrum 940, similar bandwidth is achieved and the measured peak-to-peak fluctuations are acceptable. For curve 1030, the peak-to-peak fluctuations are less than 50% of the average of the intensity within the bandwidth. For curve 1020, the peak-to-peak fluctuations appear to exceed this range somewhat. However, if considered relative to the slightly sloped profile of curve 1020, the peak-to-peak fluctuations are within the 50% limit. Both gratings associated with the spectra of FIG. 10 are suitable for use in a digital cinema projector without producing significant speckle discernible by human vision. FIG. 10 demonstrates the manufacturability and performance of the grating design of FIG. 9.

FIG. 11 shows exemplary design results for another embodiment of domain-reversed grating 112. The results of FIG. 11 are achieved using method 300, implementing both method 400 and method 500. As compared to the results shown in FIG. 9, the bandwidth of the spectra in FIG. 11 is approximately twice as large. Curve 1110 is the ensemble average [symbol] I_{NL}(Ω) [symbol] of one embodiment of broadband laser beam 120 having a triangular spectral profile. Curve 1120 is a target transfer function |D(Ω)|² received in step 410 of method 400. This target transfer function has a highly concave spectral profile to compensate for the triangular profile of the ensemble average [symbol] I_{NL}(Ω) [symbol] of the input broadband laser beam. Curve 1130 is the output transfer function |D(Ω)|² generated in step 440 and pertaining to the grating function model d_{model}(z) determined by method 400 and outputted by step 480. As is the case for the output transfer function in FIG. 9, the present output transfer function |D(Ω)|² (curve 1130) resembles the target transfer function |D(Ω)|² (curve 1120) with modulations superimposed thereon. In particular, the output transfer function |D(Ω)|² (curve 930) has a concave spectral profile with a bandwidth slightly narrower than that of the target transfer function |D(Ω)|² (curve 1120). The resulting calculated ensemble average [symbol] I_{SHG}(Ω) [symbol] of the frequency-doubled light, an example of frequency-doubled light 124, is plotted as curve 1140. All of curves 1110, 1120, 1130, and 1140 are plotted in arbitrary units as a function of the wavelength detuning in nanometers (nm) from the center wavelength. The ensemble average [symbol] I_{SHG}(Ω) [symbol] of the frequency-doubled light has a high spectral bandwidth of approximately 2.6 nm and exhibits a flat-top-like profile with modulations superimposed thereon. The peak-to-peak fluctuations are less than 50% of the average intensity of the frequency-doubled light within the bandwidth. It is understood that the peak-to-peak fluctuations pertain to the envelope of the spectrum of the frequency-doubled light, even though the spectrum of the frequency-doubled light may be at least partly composed of discrete spectral components spectrally spaced apart from each other. The 2.6 nm bandwidth in wavelength space corresponding to a ˜2.7 THz bandwidth in frequency space for a center frequency of the frequency doubled light is in the green portion of the spectrum. This large bandwidth and the relative flatness of the spectral profile combine to make the system of FIG. 11 capable of avoiding generation of speckle discernible by human vision in a digital cinema projector application.

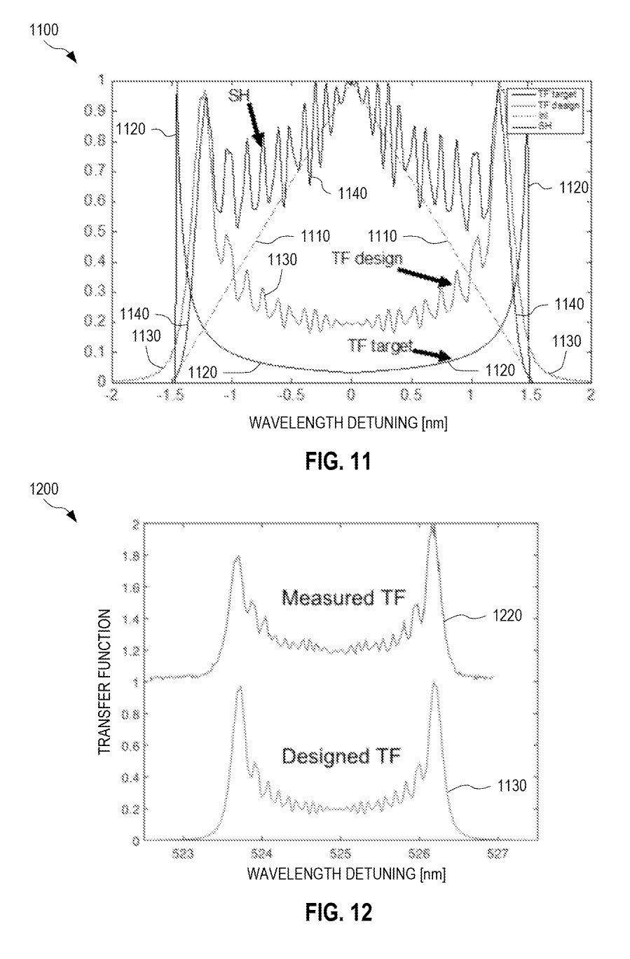

FIG. 12 shows actual measurements of the transfer function |D(Ω)|² for a domain-reversed grating designed according to output transfer function |D(Ω)|² (curve 1130) of FIG. 11, with the period of domain reversal being discretized using method 500. Curve 1220 shows the measured transfer function for the domain-reversed grating. For comparison, the output transfer function |D(Ω)|² (curve 1130) is depicted in FIG. 12 as well. The curves are offset for clarity. While the measured transfer function 1220 is not identical to the calculated transfer function 1130, similar bandwidth and peak-to-peak fluctuations are achieved. FIG. 12 demonstrates the manufacturability and performance of the grating design of FIG. 11.

FIG. 13 illustrates the impact of temperature on quasi-phase-matched frequency doubling. Plot 1300 shows a calculated ensemble average [symbol] I_{SHG}(Ω) [symbol] (curve 1310) of frequency-doubled light, an example of frequency-doubled light 124, generated in a domain-reversed grating similar to that associated with the results shown in FIG. 9. Curve 1310 is calculated assuming a uniform temperature distribution along the light propagation direction through the domain-reversed grating. Plot 1300 also shows a curve 1320 indicating a calculated ensemble average [symbol] I_{SHG}(Ω) [symbol] (curve 1310) of frequency-doubled light generated in the same domain-reversed grating as that underlying curve 1310, but assuming a temperature gradient of +10 degrees/centimeter along the light propagation direction through the domain-reversed grating. Such a temperature gradient is realistic in high-power scenarios where absorption coefficient for the frequency-doubled light is greater than that of the input light, which is commonly the case. FIG. 13 demonstrates that the impact of such a temperature gradient may be drastic. However, the temperature effect may be accounted for in the design process, for example in step 318 of method 300 and in step 442 of method 400, by properly incorporating absorption into the calculations based upon relevant absorption coefficients.

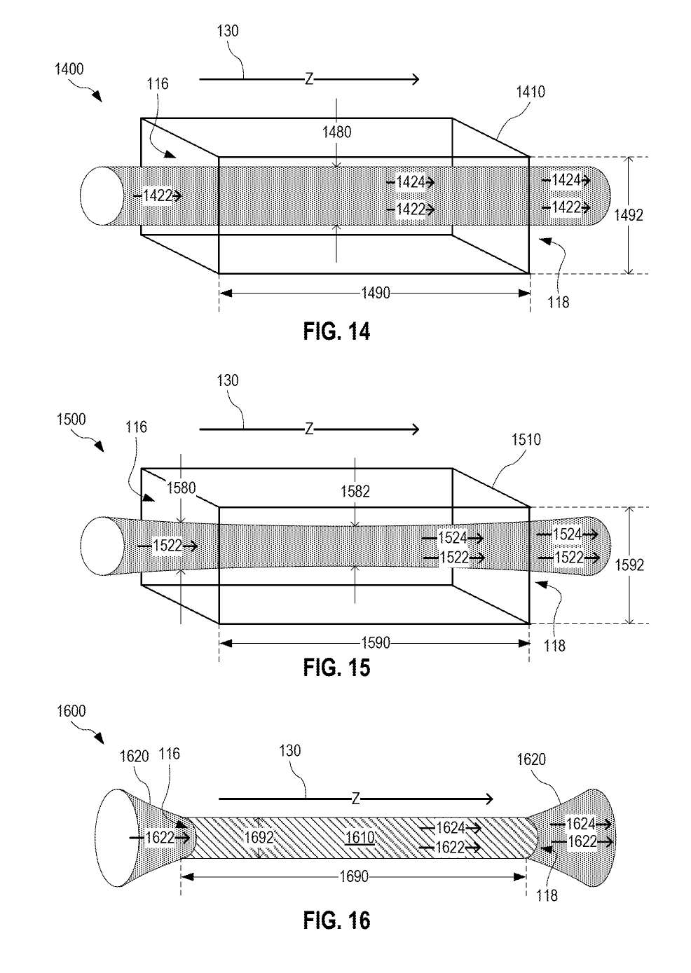

FIG. 14 illustrates one exemplary bulk domain-reversed grating 1400 in a scenario, wherein the broadband input light is a collimated broadband laser beam 1422. Bulk domain-reversed grating 1400 is an embodiment of domain-reversed grating 112, and collimated broadband laser beam 1422 is an example of broadband laser beam 122. During propagation through bulk domain-reversed grating 1400, collimated broadband laser beam 1422 is at least partly converted to frequency-doubled light 1424. Frequency-doubled light 1424 is an example of frequency-doubled light 124.

Bulk domain-reversed grating 1400 has length 1490 along light propagation direction 130. The diameter 1480 of collimated broadband laser beam 1422 is substantially constant along light propagation direction 130. Without departing from the scope hereof, the profile of collimated broadband laser beam 1422 may be elliptical rather than circular, however with the dimensions of the elliptical cross section being substantially unchanged over the full length 1490. In an exemplary use scenario, the characteristic size 1492 of bulk domain-reversed grating 1400, in dimensions orthogonal to light propagation direction 130, exceeds diameter 1480. In this scenario, collimated broadband laser beam 1422, and frequency-doubled light 1424 generated therefrom, are fully contained within the transverse dimensions of bulk domain-reversed grating 1400 (except for possible scattered components of the light).

In certain embodiments, length 1490 is in the range between 0.5 and 6 centimeters. In order to maintain a substantially constant diameter 1480 over a value of length 1490 in this range, diameter 1480 must be relatively large, for example at least about one millimeter. Collimated broadband laser beam 1422 may a single-spatial-mode laser beam or a multi-spatial-mode laser beam.

FIG. 15 illustrates one exemplary bulk domain-reversed grating 1500 in a scenario, wherein the broadband input light is a focused broadband laser beam 1522. Bulk domain-reversed grating 1500 is an embodiment of domain-reversed grating 112, and focused broadband laser beam 1522 is an example of broadband laser beam 122. During propagation through bulk domain-reversed grating 1500, focused broadband laser beam 1522 is at least partly converted to frequency-doubled light 1524. Frequency-doubled light 1524 is an example of frequency-doubled light 124.

Bulk domain-reversed grating 1500 has length 1590 along light propagation direction 130. The diameter 1580 of focused broadband laser beam 1522 is function of the position z along light propagation direction 130. At input end 116 of bulk domain-reversed grating 1500, focused broadband laser beam 1522 has diameter 1580, but focused broadband laser beam 1522 comes to a focus characterized by a minimum diameter 1582 inside bulk domain-reversed grating 1500. Without departing from the scope hereof, the profile of focused broadband laser beam 1522 may be elliptical rather than circular. In an exemplary use scenario, the characteristic size 1592 of bulk domain-reversed grating 1500, in dimensions orthogonal to light propagation direction 130, exceeds diameter 1580. In this scenario, focused broadband laser beam 1522, and frequency-doubled light 1524 generated therefrom, are fully contained within the transverse dimensions of bulk domain-reversed grating 1500 (except for possible scattered components of the light).

As compared to collimated broadband laser beam 1422, focused broadband laser beam 1522 has at least one advantage. While having the same power as collimated broadband laser beam 1422, focused broadband laser beam 1522 has greater intensity by virtue of being focused to a smaller diameter 1582. To a first approximation, this greater intensity results in significantly higher efficiency of frequency doubling, since frequency doubling is a nonlinear process. Thus, operation with focused broadband laser beam 1522 may lead to increased efficiency of frequency doubling. On the other hand, diffraction effects may be of significance and a more complex temperature distribution may result from the diameter of focused broadband laser beam 1522 varying and achieving a focus. However, these effects may be taken into account in each of methods 300 and 400, as discussed above in reference to FIGS. 3 and 4, such that bulk domain-reversed grating 1500 may be designed to accommodate focused broadband laser beam 1522. In scenarios where focused broadband laser beam 1522 is not very strongly focused, it may be appropriate to omit diffraction effects and assume plane-wave propagation through bulk domain-reversed grating 1500. For example, when the Rayleigh range of focused broadband laser beam 1522 is longer than half of length 1590, design calculations in methods 300 and 400 may be performed assuming plane-wave propagation without significant loss of accuracy.

In certain embodiments, length 1590 is in the range between 0.5 and 6 centimeters. Diameter 1582 may be as small as on the order of a few micrometers. Focused broadband laser beam 1522 may a single-spatial-mode laser beam or a multi-spatial-mode laser beam.

FIG. 16 illustrates one exemplary waveguide-based domain-reversed grating 1600 having a constant diameter 1692. Waveguide-based domain-reversed grating 1600 is an embodiment of domain-reversed grating 112. In an exemplary scenario, a broadband laser beam 1622 is coupled into waveguide-based domain-reversed grating 1600 and propagates through waveguide-based domain-reversed grating 1600 in a propagation mode of waveguide-based domain-reversed grating 1600, wherein this propagation mode is characterized by a constant mode field diameter. Broadband laser beam 1622 is a single-spatial-mode laser beam. The waveguide based propagation ensures plane-wave propagation throughout waveguide-based domain-reversed grating 1600. Broadband laser beam 1622 is an example of broadband laser beam 122. During propagation through waveguide-based domain-reversed grating 1600, broadband laser beam 1622 is at least partly converted to frequency-doubled light 1624. Frequency-doubled light 1624 is an example of frequency-doubled light 124 and propagates through waveguide-based domain-reversed grating 1600 in a propagation mode thereof. The propagation properties of both broadband laser beam 1622 and frequency-doubled light 1624 generated therefrom remain uniform throughout propagation through waveguide-based domain-reversed grating 1600. This simplifies the calculations required to design waveguide-based domain-reversed grating 1600, as compared to bulk domain-reversed gratings (especially if operated with a focused laser beam such as focused broadband laser beam 1522).

Waveguide-based domain-reversed grating 1600 has length 1690 along light propagation direction 130. In certain embodiments, length 1690 is in the range between 0.5 and 6 centimeters. The diameter of broadband laser beam 1622 may be similar to diameter 1692 such that broadband laser beam 1622 substantially fills waveguide-based domain-reversed grating 1600. In one embodiment, diameter 1692 is in the range between 1 and 100 micrometers, for example around 10 micrometers or in the range between 5 and 15 micrometers. Broadband laser beam 1622 may be coupled into waveguide-based domain-reversed grating 1600 using methods and optical components known in the art. Without departing from the scope hereof, diameter 1692 may be a vary along propagation direction 130 as long as waveguide-based domain-reversed grating 1600 guides broadband laser beam 1622 in a mode characterized by constant mode field diameter.

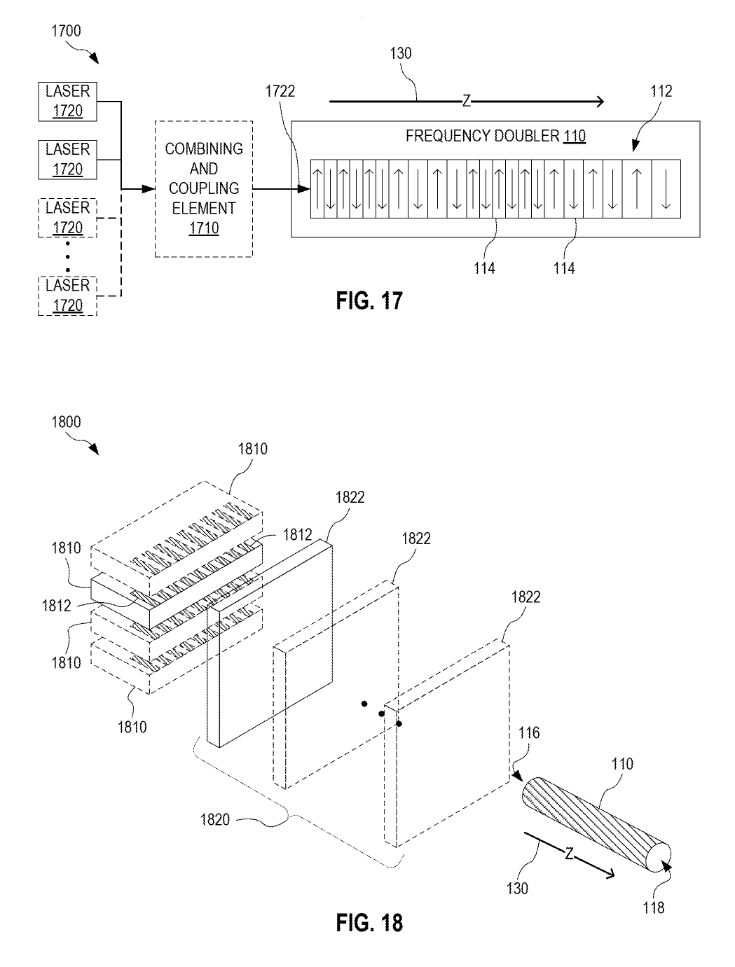

FIG. 17 illustrates one exemplary frequency-doubled broadband light source 1700. Frequency-doubled broadband light source 1700 generates broadband frequency-doubled light 124 from a plurality of lasers 1720 through quasi-phase-matched frequency doubling in domain-reversed grating 112. At least some of lasers 1720 produce light at different respective wavelengths, such that a broadband laser beam 1722 is formed as an aggregate of the plurality of lasers 1720. Frequency-doubled broadband light source 1700 is an embodiment of system 100 and may include 2 or more lasers 1720. Broadband laser beam 1722 is an example of broadband laser beam 122. In certain embodiments, frequency-doubled broadband light source 1700 includes between 20 and 150 lasers 1720 producing light at different respective wavelengths. The spectra of individual ones of lasers 1720 may overlap or be spaced apart. As a result, the spectrum of broadband laser beam 1722, formed from lasers 1720, may be continuous or discrete or a combination thereof. In one embodiment, each of lasers 1720 is a diode laser, for example a narrowband diode laser.

Frequency-doubled broadband light source 1700 may include a combining and coupling element 1710 that combines and couples the light produced by each of lasers 1720 into domain-reversed grating 112. Combining and coupling element 1710 may include one or more lenses, lens arrays, gratings, and/or waveguide-based systems.

In one embodiment, each of diode lasers 1720 is near-infrared and frequency-doubled light generated from broadband laser beam 1722 is green. Frequency-doubled broadband light source may produce between 1 and 100 watts of frequency-doubled light, for example in the green portion of the visible spectrum.

Frequency-doubled broadband light source 1700 may implement domain-reversed grating 112 according to one of the configurations shown in FIGS. 14, 15, and 16, for example.

FIG. 18 illustrates one exemplary diode laser based frequency-doubled broadband light source 1800 for generating broadband frequency-doubled light 124 from a plurality of diode lasers 1812 through quasi-phase-matched frequency doubling in domain-reversed grating 112. Diode lasers 1812 are integrated in one or more diode bars 1810. Each diode bar 1810 includes a plurality of diode lasers 1812. Frequency-doubled broadband light source 1800 is an embodiment of frequency-doubled broadband light source 1700. Each diode laser 1812 is an embodiment of diode laser 1720. The collection of diode lasers 1812 include diode lasers 1812 at different wavelengths such that diode lasers 1812 combine to form broadband laser beam 1722. Frequency-doubled broadband light source 1800 includes a coupling element 1820 that couples light produced by each of diode lasers 1812 into input end 116 of domain-reversed grating 112 within frequency doubler 110. For clarity of illustration, FIG. 18 does not explicitly show domain-reversed grating 112. Coupling element 1820 may include one or more serially configured coupling components 1822, such as a series of lenses/lens arrays as known in the art.

In one embodiment, frequency-doubled broadband light source 1800 implements frequency doubler 110 with waveguide-based domain-reversed grating 1600. In another embodiment, frequency doubler 110 includes a bulk domain-reversed grating such as bulk domain-reversed grating 1400 or 1500.

In certain embodiments, diode lasers 1812 are near-infrared to generate green light in frequency doubler 110. Near-infrared diode lasers at wavelengths that are twice that of green light are relatively inexpensive, such that this embodiment of system 1800 is more cost effective than an array of green laser diodes without frequency doubling.

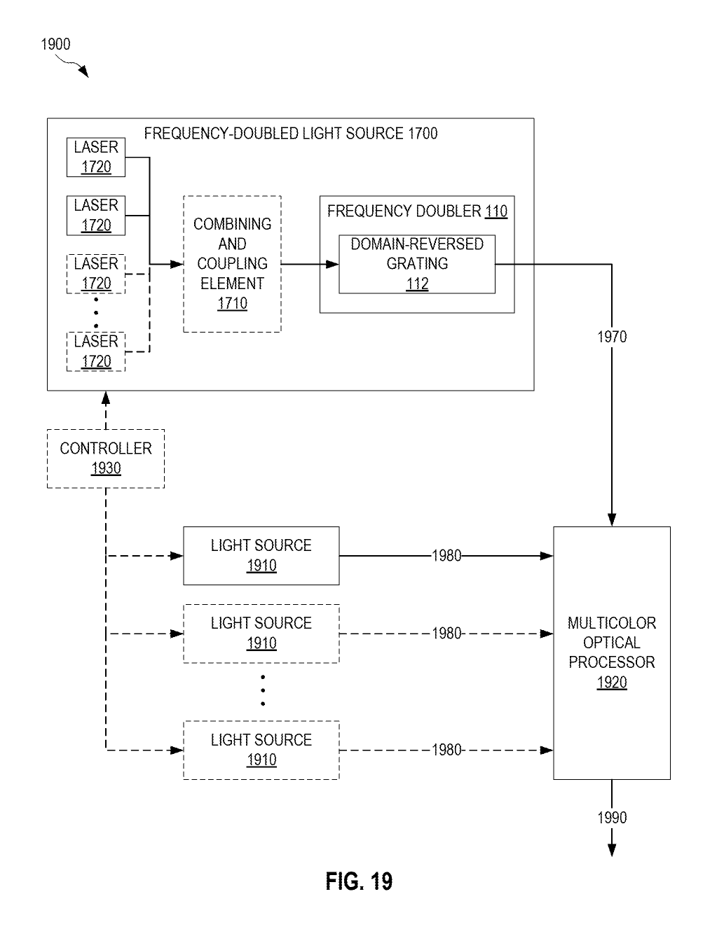

FIG. 19 illustrates one exemplary multi-colored light system 1900 that includes frequency-doubled broadband light source 1700. System 1900 further includes at least one additional light-source 1910 and a multi-color optical processor 1920. Multi-color optical processor 1920 processes broadband frequency-doubled light 1970 produced by frequency-doubled broadband light source 1700 and light 1980 produced by each light source 1910 to produce multi-colored light 1990. Frequency-doubled light 1970 is an example of frequency-doubled light 124. In one embodiment, multi-color optical processor 1920 is a projection system that directs multi-color light 1990 to a screen to form an image. This projection system may be a digital cinema projector or a projector configured for use in a different a non-cinema setting. In embodiments, multi-color light system 1900 includes a controller 1930 that controls the operation of frequency-doubled broadband light source 1700 and each of light sources 1910.

In one embodiment, frequency-doubled broadband light source 1700 generates light in the green portion of the visible spectrum and system 1900 further includes two light sources 1910, one of which is a red laser and the other being a blue laser. In this embodiment, each of diode lasers 1720 is near-infrared. Without departing from the scope hereof, system 1900 may include a plurality of frequency-doubled broadband light sources 1700 to achieve a desired aggregated power. In one such example, each frequency-doubled broadband light source 1700 generates approximately 10 watts of green light, and system 1900 includes between 5 and 20 frequency-doubled broadband light sources 1700 to produce a total of approximately 50 and 200 watts of green light. Also without departing from the scope hereof, system 1900 may implement another embodiment of system 100, or several instances thereof, in place of frequency-doubled broadband light source 1700.

Multi-color light system 1900 is capable of projecting frequency-doubled light 1970 onto a screen without producing visible speckle.

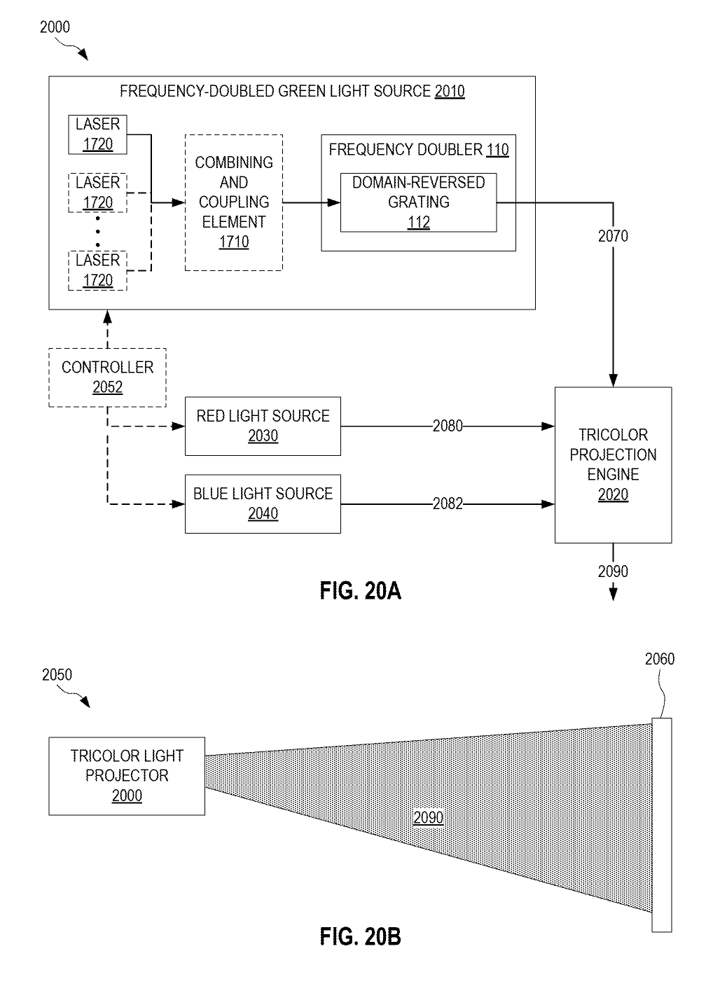

FIG. 20A illustrates one exemplary tricolor projection system 2000 that includes a frequency-doubled broadband green light source 2010, a red light source 2030, and a blue light source 2040. Each of red light source 2030 and blue light source 2040 may be a laser. Frequency-doubled broadband green light source 2010 produces green broadband light 2070. Red light source 2030 produces red light 2080 which may be broadband. Blue light source 2040 produces blue light 2082 which may be broadband. Tricolor projection system 2000 is similar to an embodiment of multi-color light system 1900 implementing two light sources 1910 as red light source 2030 and blue light source 2040. As compared to such an embodiment of multi-color light system 1900, (a) tri-color light system may include only one diode laser 1720 (or alternate type of laser without departing from the scope hereof) (b) controller 1930 is replaced by a controller 2052 specifically configured to control frequency-doubled broadband green light source 2010, red light source 2030, and blue light source 2040, and (c) multi-color optical processor 1920 is replaced by a tricolor projection engine 2020 that projects, onto a screen, tricolor light 2090 produced from green broadband light 2070, red light 2080, and blue light 2082.

Tricolor projection system 2000 may be configured to project between 10 and hundreds of watts of each of green broadband light 2070, red light 2080, and blue light 2082.

FIG. 20B shows tricolor projection system 2000 in operation. Tricolor projection system 2000 projects tricolor light 2090 onto a screen 2060 to form tricolor images on the screen. Tricolor projection system 2000 may be used as a digital cinema projector. By virtue of the broadband nature of green broadband light 2070, tricolor projection system 2000 may project green broadband light 2070 onto a screen without causing speckle discernible by a human observer. In certain embodiments, red light 2080 and blue light 2082 are sufficiently broadband to avoid speckle discernible by a human observer.

In one implementation, one or both of red light source 2030 and blue light source 2040 includes a corresponding embodiment of system 100.

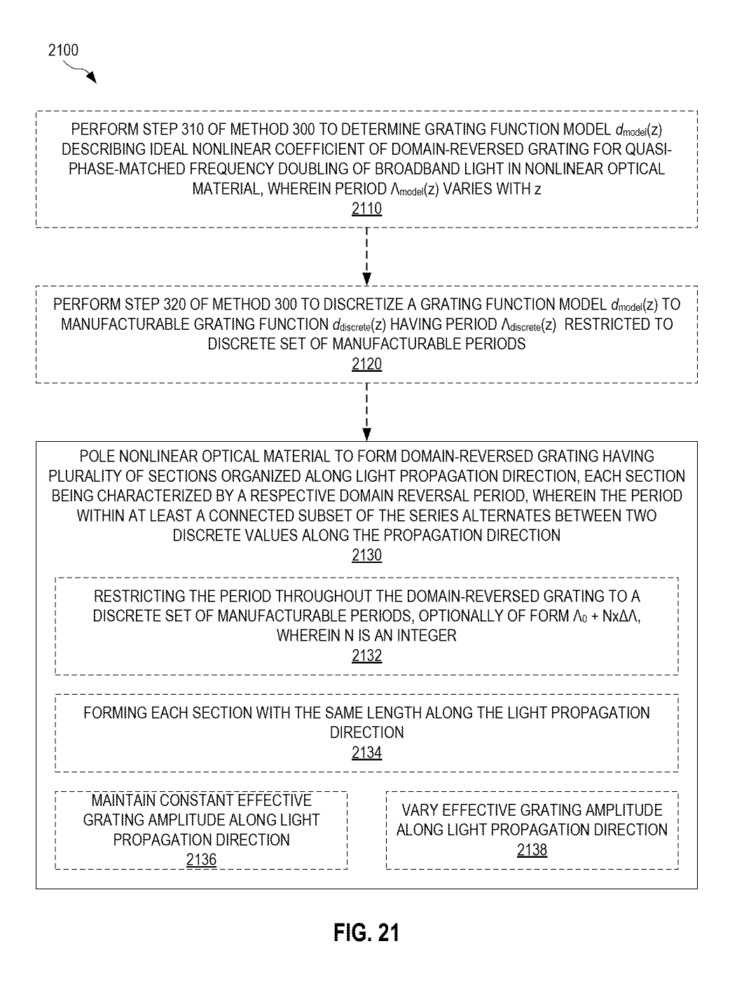

FIG. 21 illustrates one exemplary method 2100 for manufacturing a frequency doubler for quasi-phase-matched frequency doubling of broadband light with uncorrelated spectral phase. Method 2100 may be used to manufacture frequency doubler 110 or domain-reversed grating 112, for example according to any one of the embodiments shown in FIGS. 7 and 14-16.

In a step 2130, method 2100 poles a nonlinear optical material to form a domain-reversed grating having a plurality of sections organized along the light propagation direction. Each section is characterized by a respective domain reversal period, wherein the period within at least a connected subset of the series alternates between two discrete values along the propagation direction. An example of such a grating is discussed above in reference to FIG. 7. In one example of step 2130, a poling apparatus known in the art forms domains 114 in a ferroelectric nonlinear optical material to form an embodiment of domain-reversed grating 112 having at least a portion thereof configured in a manner similar to that of domain-reversed grating 700.

Step 2130 may implement a step 2132 of restricting the period of domain reversal throughout the domain-reversed grating to a discrete set of manufacturable periods. These manufacturable periods may be of the form Λ₀+N·ΔΛ discussed above in reference to step 324. Step 2130 may also implement a step 2134 of forming each section with the same length along the light propagation direction. FIG. 7 shows an example of such an embodiment, wherein each section 710 has length Δz along light propagation direction 130. Step 2130 further implements either a step 2136 or a step 2138. Step 2136 maintains a constant effective grating amplitude along the light propagation direction. In one example of step 2136, the poling apparatus is configured to pole each of domains 114 of domain-reversed grating 112 with the same effective grating amplitude. Step 2138 varies the effective grating amplitude along at least a portion of the light propagation through the domain-reversed grating. In one example of step 2138, the poling apparatus varies the effective grating amplitude of domains 114 along light propagation direction 130.

In certain embodiments, step 2130 is preceded by a step 2120 of performing step 320 of method 300 to discretize a grating function model d_{model}(z) to form a manufacturable grating function d_{discrete}(Z) having period Λ_{discrete}(Z) restricted to a discrete set of manufacturable periods. The period function Λ_{discrete}(Z) defines the poling pattern formed by the poling apparatus in step 2130. Step 2120 may implement method 500. In an embodiment, step 2120 includes step 322 and/or step 324.

In embodiments, step 2120 is preceded by a step 2110 of performing step 310 of method 300 to determine grating function model d_{model}(Z), wherein the period of domain reversal of d_{model}(Z) is a non-uniform function of the position z. In an embodiment, step 2110 implements method 300. Step 2110 may include step 312, either one of steps 314 and 316, and/or step 318.

Changes may be made in the above devices, systems and methods without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present devices, systems, and methods, which, as a matter of language, might be said to fall therebetween.

What is claimed is:

1. A device for quasi-phase-matched frequency doubling of broadband light with uncorrelated spectral phase, comprising:
a nonlinear optical material including a domain-reversed grating organized in a series of sections along the propagation direction of the broadband light through the nonlinear optical material, each of the sections being characterized by a respective period of the domain-reversed grating, the period within a first connected subset of the series alternating between two discrete values along the propagation direction.

2. The device of claim 1, the period throughout the domain-reversed grating being restricted to Λ₀+N·ΔΛ, N being an integer.

3. The device of claim 2, the period within the first connected subset of the series alternating between Λ₀+N₁·ΔΛ and Λ₀+N₂·ΔΛ, N₁ being an integer and N₂=N₁+1, such that each section located within the first connected subset and having period Λ₀+N₁·ΔΛ is adjacent a section having period Λ₀+N₂·ΔΛ.

4. The device of claim 3, the domain-reversed grating further comprising a second connected subset of the series, the period within the second connected subset alternating between Λ₀+N₂·ΔΛ and Λ₀+N₃·ΔΛ, N₃=N₂+1, such that each section located within the second connected subset and having period Λ₀+N₂·ΔΛ is adjacent a section having period Λ₀+N₃·ΔΛ.

5. The device of claim 4, the period of any section located between the first connected subset and the second connected subset being Λ₀+N₂·ΔΛ.

6. The device of claim 1, each of the sections having same extent along the propagation direction.

7. The device of claim 6, the extent being in range between 1 and 100 nanometers.

8. A system for generating broadband frequency-doubled light, comprising:
a first laser for emitting a broadband laser beam containing a plurality of frequency components having uncorrelated spectral phase; and
a frequency doubler coupled with the first laser and including a domain-reversed grating, in a nonlinear optical material, for quasi-phase-matched frequency doubling of the plurality of frequency components to generate the broadband frequency-doubled light,
wherein the period of domain-reversal in the domain-reversed grating exhibits variation along propagation direction of the broadband laser beam through the nonlinear optical material.

9. The system of claim 8, the first laser being a continuous-wave laser.

10. The system of claim 8, the first laser being a pulsed laser.

11. The system of claim 10, the pulse length of the broadband laser beam being at least 10 times transform limited pulse length associated with spectrum of the broadband laser beam.

12. The system of claim 8, the domain-reversed grating being organized in a series of sections along the propagation direction, each of the sections being characterized by a respective period of the domain-reversed grating, the period being restricted to a discrete set of manufacturable values.

13. The system of claim 12, the period being restricted to Λ₀+N·ΔΛ, N being an integer.

14. A method for manufacturing a frequency doubler for quasi-phase-matched frequency doubling of broadband light with uncorrelated spectral phase, comprising:
poling a nonlinear optical material to form a domain-reversed grating having a plurality of sections organized along propagation direction of the broadband light through the nonlinear optical material, each of the sections being characterized by a respective period of the domain-reversed grating, the period within at least a connected subset of the series alternating between two discrete values along the propagation direction.

15. The method of claim 14, the step of poling comprising forming the domain-reversed grating with the period being restricted to a discrete set of manufacturable periods.

16. The method of claim 15, the discrete set of manufacturable periods being of form Λ₀+N·ΔΛ, N being an integer.

17. The method of claim 15, the step of poling comprising forming each of the sections to have same extent along the propagation direction.

18. The method of claim 17, in the step of poling, the extent being in range between 1 and 100 nanometers.

19. The method of claim 14, the step of poling comprising forming the domain-reversed grating with length along the propagation direction being in range from 0.5 to 6.0 centimeters.
